(19) United States
(12) Patent Application Publication
(10) Pub. No.: US 2015/0261106 A1
(43) Pub. Date: Sep. 17, 2015

(54) ELECTROPHOTOGRAPHIC PHOTOSENSITIVE MEMBER

(71) Applicant: KYOCERA DOCUMENT SOLUTIONS INC., Osaka (JP)

(72) Inventors: Jun AZUMA, Osaka (JP); Kensuke OKAWA, Osaka (JP); Akihiko OGATA, Osaka (JP); Takahiro OKI, Osaka (JP)

(73) Assignee: KYOCERA DOCUMENT SOLUTIONS INC., Osaka (JP)

(21) Appl. No.: 14/656,102

(22) Filed: Mar. 12, 2015

(30) Foreign Application Priority Data
Mar. 13, 2014 (JP) 2014-049988
Mar. 25, 2014 (JP) 2014-062036

(51) Int. Cl. G03G 5/06; G03G 5/05

(52) U.S. Cl. CPC G03G 5/0614; G03G 5/0546

(57) ABSTRACT

An electrophotographic photosensitive member includes a photosensitive layer. The photosensitive layer is a single-layer photosensitive layer or a multi-layer photosensitive layer having a charge transport layer as an outermost layer. Silica particles are contained in the photosensitive layer in an amount of no less than 0.5 parts by mass and no greater than 15 parts by mass relative to 100 parts by mass of a binder resin. The binder resin includes a polycarbonate resin represented by the general formula (1a) or the general formula (1b).

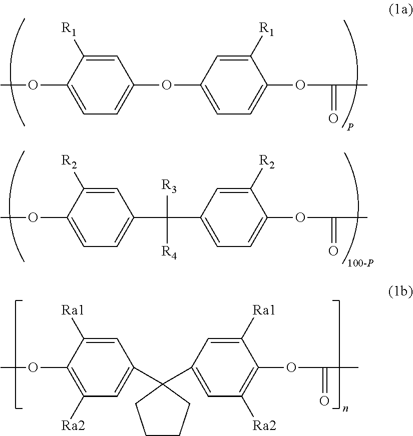

### INCORPORATION BY REFERENCE

The present application claims priority under 35 U.S.C. §119 to Japanese Patent Application Nos. 2014-49988 filed Mar. 13, 2014 and 2014-62036 filed Mar. 25, 2014. The contents of these applications are incorporated herein by reference in their entirety.

### BACKGROUND

The present disclosure relates to an electrophotographic photosensitive member.

Electrophotographic printers and multifunction peripherals include an electrophotographic photosensitive member as an image bearing member. In general, an electrophotographic photosensitive member includes a conductive substrate and a photosensitive layer disposed directly or indirectly on the conductive substrate. A photosensitive member including a photosensitive layer containing a charge generating material, a charge transport material, and a resin for binding these materials (organic materials) is referred to as electrophotographic organic photosensitive member. An electrophotographic organic photosensitive member including: a layer mainly containing a charge transport material and thus having a charge transporting function; and a layer mainly containing a charge generating material and thus having a charge generating function is referred to as multi-layer electrophotographic photosensitive member. An electrophotographic organic photosensitive member including a single layer containing a charge transport material and a charge generating material and achieving both the charge generating function and the charge transporting function by the single layer is referred to as single-layer electrophotographic photosensitive member.

A photosensitive member containing an inorganic material (e.g., selenium or amorphous silicon) is referred to as electrophotographic inorganic photosensitive member. At present, the electrophotographic organic photosensitive member is used in many image forming apparatuses as being advantageous in terms of less negative impact on the environment, ease of film formation, and ease of manufacture compared to the electrophotographic inorganic photosensitive member.

The photosensitive layer of the electrophotographic organic photosensitive member contains, as a charge transport material, a hole transport material for transporting holes. Known examples of compounds that can be suitably used as the hole transport material include butadienylbenzene amine derivatives.

### SUMMARY

An electrophotographic photosensitive member of the present disclosure includes a photosensitive layer. The photosensitive layer is a multi-layer photosensitive layer including a laminate of a charge generating layer containing a charge generating material and a charge transport layer containing a charge transport material, a binder resin, and silica particles, the charge transport layer being an outermost layer. Alternatively, the photosensitive layer is a single-layer photosensitive layer containing a charge generating material, a charge transport material, a binder resin, and silica particles. The silica particles are contained in the photosensitive layer in an amount of no less than 0.5 parts by mass and no greater than 15 parts by mass relative to 100 parts by mass of the binder resin. The binder resin includes a polycarbonate resin represented by the general formula (1a) or the general formula (1b).

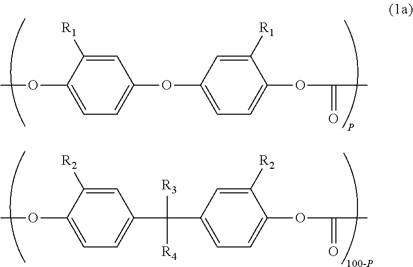

In the general formula (1a), R₁ and R₂ each independently represent a hydrogen atom, or a substituted or unsubstituted alkyl group. R₃ and R₄ each independently represent a hydrogen atom, a substituted or unsubstituted alkyl group, or a substituted or unsubstituted aryl group. R₃ and R₄ may be joined together to form a cycloalkylidene group. P is greater than 0 and no greater than 100. P and 100-P each represent the proportion of a repeating structural unit in the polycarbonate resin.

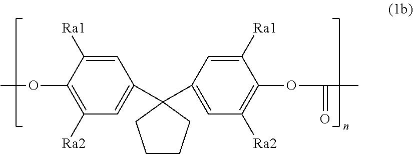

In the general formula (1b), Ra₁ and Ra₂ each independently represent a hydrogen atom or an alkyl group having 1 to 3 carbon atoms.

### BRIEF DESCRIPTION OF THE DRAWINGS

FIGS. 1A and 1B are schematic cross sectional views each illustrating a structure of a multi-layer electrophotographic photosensitive member according to an embodiment of the present disclosure.

FIGS. 2A and 2B are schematic cross sectional views each illustrating a structure of a single-layer electrophotographic photosensitive member according to an embodiment of the present disclosure.

### DETAILED DESCRIPTION

Hereinafter, an embodiment of the present disclosure will be described in detail. However, the present disclosure is in no way limited to the embodiment, and appropriate alterations may be made to practice the present disclosure within the scope of the aim of the present disclosure. It should be noted that explanation may be omitted where appropriate in order to avoid repetition, but such omission does not limit the gist of the present disclosure.

An electrophotographic photosensitive member (hereinafter, may be referred to simply as “photosensitive member”) according to the present embodiment includes a photosensitive layer. The photosensitive layer contains a charge generating material, a charge transport material, a binder resin, and silica particles.

In the electrophotographic photosensitive member of the present embodiment, the photosensitive layer is a multi-layer photosensitive layer or a single-layer photosensitive layer.

For example, the electrophotographic photosensitive member of the present embodiment includes a substrate and a photosensitive layer provided on the substrate. The photosensitive layer in the electrophotographic photosensitive member may be a multi-layer photosensitive layer or a single-layer photosensitive layer. The photosensitive layer contains a polycarbonate resin having a specified structure and silica particles.

The electrophotographic photosensitive member of the present embodiment may be a multi-layer electrophotographic photosensitive member including a multi-layer photosensitive layer. The multi-layer photosensitive layer contains at least a charge generating layer and a charge transport layer disposed as an outermost layer. The charge generating layer contains at least a charge generating material. The charge transport layer contains a charge transport material, a binder resin, and silica particles.

For example, the multi-layer electrophotographic photosensitive member includes a substrate and a photosensitive layer. The photosensitive layer includes a charge generating layer and a charge transport layer. The multi-layer electrophotographic photosensitive member is prepared by laminating the charge generating layer and the charge transport layer to the substrate by application or the like. The charge generating layer contains a charge generating material. The charge transport layer contains a binder resin, a charge transport material, and silica particles. The charge generating layer may be single-layer or multi-layer. The charge transport layer may be single-layer or multi-layer.

The charge transport layer has a smaller film thickness than the charge generating layer in a general multi-layer electrophotographic photosensitive member. The multi-layer electrophotographic photosensitive member has the charge transport layer as an outermost layer, and therefore abrasion and damage in the charge generating layer can be restricted even when the multi-layer electrophotographic photosensitive member is used for a long period of time.

The electrophotographic photosensitive member of the present embodiment may be a single-layer electrophotographic photosensitive member having a single-layer photosensitive layer. The single-layer photosensitive layer contains at least a charge generating material, a charge transport material, a binder resin, and silica particles within the same layer.

For example, the single-layer electrophotographic photosensitive member includes a substrate and a photosensitive layer. The photosensitive layer is formed on the substrate by application or the like.

The binder resin used in the present embodiment includes a polycarbonate resin represented by the general formula (1a) or the general formula (1b).

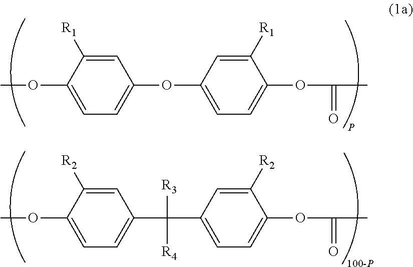

In the general formula (1a), R₁ and R₂ each independently represent a hydrogen atom, or a substituted or unsubstituted alkyl group. R₃ and R₄ each independently represent a hydrogen atom, a substituted or unsubstituted alkyl group, or a substituted or unsubstituted aryl group. R₃ and R₄ may be joined together to form a cycloalkylidene group. P is greater than 0 and no greater than 100. P and (100-P) each represent the proportion (molar proportion) of a repeating structural unit in the polycarbonate resin.

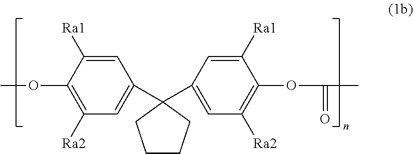

In the general formula (1b), Ra₁ and Ra₂ each independently represent a hydrogen atom or an alkyl group having 1 to 3 carbon atoms. The letter n represents a degree of polymerization.

The electrophotographic photosensitive member of the present embodiment includes a photosensitive layer containing the binder resin represented by the general formula (1a) or the general formula (1b) and silica particles. The photosensitive layer containing the binder resin represented by the general formula (1a) and silica particles is excellent in abrasion resistance and oil cracking resistance. Accordingly, an image forming apparatus including the electrophotographic photosensitive member of the present embodiment is excellent in durability and capable of forming high-quality images over a long period of time. The photosensitive layer containing the binder resin represented by the general formula (1b) and silica particles can provide ozone resistance and abrasion resistance while maintaining excellent electrical characteristics.

### <Multi-Layer Electrophotographic Photosensitive Member>

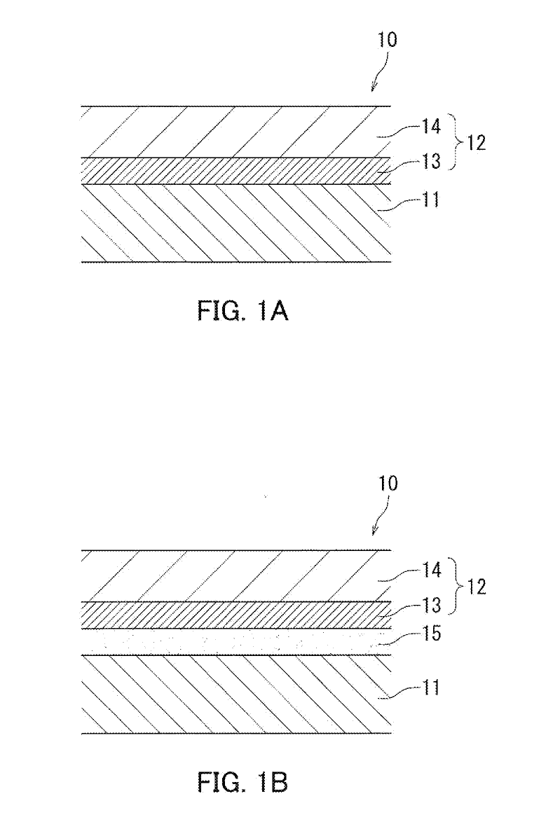

Hereinafter, a multi-layer electrophotographic photosensitive member including a multi-layer photosensitive layer will be described with reference to FIGS. 1A and 1B. As shown in FIG. 1A, a multi-layer electrophotographic photosensitive member 10 includes a substrate 11 and a multi-layer photosensitive layer 12. The multi-layer photosensitive layer 12 includes a charge generating layer 13 and a charge transport layer 14. That is, the multi-layer electrophotographic photosensitive member 10 includes the multi-layer photosensitive layer 12 in which the charge generating layer 13 and the charge transport layer 14 are laminated to the substrate 11 in the noted order. With the charge transport layer 14 disposed as the outermost layer of the multi-layer photosensitive layer 12, it is possible to enhance the abrasion resistance and the oil cracking resistance of the multi-layer photosensitive layer 12 while maintaining excellent electrical characteristics of the multi-layer electrophotographic photosensitive member 10.

The charge generating layer 13 contains a charge generating material. The charge transport layer 14 contains a charge transport material, a binder resin, and silica particles. The charge transport layer 14 may contain an electron acceptor compound as needed.

The multi-layer electrophotographic photosensitive member 10 may be provided with an intermediate layer 15 between the substrate 11 and the multi-layer photosensitive layer 12 as shown in FIG. 1B, for example.

The thickness of each of the charge generating layer 13 and the charge transport layer 14 is not particularly limited so long as each of the layers can function sufficiently. The specific thickness of the charge generating layer 13 is preferably no less than 0.01 μm and no greater than 5 μm, and more preferably no less than 0.10 μm and no greater than 3 μm. The specific thickness of the charge transport layer 14 is preferably no less than 2 μm and no greater than 100 μm, and more preferably no less than 5 μm and no greater than 50 μm.

The intermediate layer 15 may be provided between the substrate 11 and the charge generating layer 13 or between the charge generating layer 13 and the charge transport layer 14. The intermediate layer 15 included in the multi-layer electrophotographic photosensitive member 10 enhances the adhesion between the substrate 11 and the photosensitive layer 12. Furthermore, by adding a specified fine power to the intermediate layer 15, it is possible to restrict occurrence of interference stripes through scattering of incident light and also to restrict charge injection into the photosensitive layer 12 from the substrate 11, which occurs when the photosensitive layer 12 is not exposed to light and causes fogging and black spots.

The fine powder that may be added to the intermediate layer 15 is not particularly limited so long as it has light scattering and dispersion properties, and examples thereof include white pigments (e.g., titanium oxide, zinc oxide, zinc white, zinc sulfide, white lead, and lithopone), inorganic pigments used as extender pigments (e.g., alumina, calcium carbonate, and barium sulfate), fluororesin particles, benzoguanamine resin particles, and styrene resin particles.

Preferably, the intermediate layer 15 has a film thickness of no less than 0.1 μm and no greater than 50 μm.

As described above, inclusion of the intermediate layer 15 in the multi-layer electrophotographic photosensitive member 10 has an effect of restricting charge injection from the substrate 11 and thus preventing partial insulation breakdown in the multi-layer electrophotographic photosensitive member 10.

The multi-layer electrophotographic photosensitive member 10 includes the charge generating layer 13 and the charge transport layer 14. In the multi-layer electrophotographic photosensitive member, therefore, a base resin for charge generating layer formation is preferably a different resin from the binder resin in order to prevent the base resin from being dissolved in a solvent used for an application liquid for charge transport layer formation.

The charge generating material is preferably contained in an amount of no less than 5 parts by mass and no greater than 1,000 parts by mass, and more preferably in an amount of no less than 30 parts by mass and no greater than 500 parts by mass relative to 100 parts by mass of the base resin contained in the charge generating layer 13. Preferably, the charge generating layer 13 has a film thickness of no less than 0.1 μm and no greater than 5 μm.

### <Single-Layer Electrophotographic Photosensitive Member>

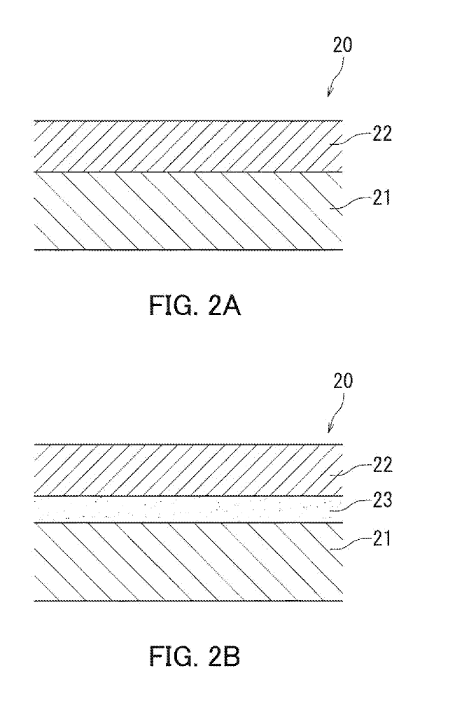

Hereinafter, a single-layer electrophotographic photosensitive member including a single-layer photosensitive layer will be described with reference to FIGS. 2A and 2B. As shown in FIG. 2A, a single-layer electrophotographic photosensitive member 20 includes a substrate 21 and a single-layer photosensitive layer 22. The single-layer photosensitive layer 22 is provided on the substrate 21. The single-layer photosensitive layer 22 contains a charge generating material, a charge transport material, a binder resin, and silica particles. The single-layer photosensitive layer 22 may contain an electron acceptor compound as needed.

The single-layer photosensitive layer 22 in the single-layer electrophotographic photosensitive member 20 may be disposed directly on the substrate 21 as shown in FIG. 2A, for example. Alternatively, an intermediate layer 23 may be provided between the substrate 21 and the single-layer photosensitive layer 22 as shown in FIG. 2B.

The thickness of the single-layer photosensitive layer 22 is not particularly limited so long as the layer can sufficiently function as the photosensitive layer. Specifically, the single-layer photosensitive layer 22 preferably has a thickness of no less than 5 μm and no greater than 100 μm, and more preferably no less than 10 μm and no greater than 50 μm.

In order to prevent occurrence of image deletion and reduce manufacturing costs, the photosensitive layer (the multi-layer photosensitive layer 12 or the single-layer photosensitive layer 22) is disposed as the outermost layer of the electrophotographic photosensitive member (the multi-layer electrophotographic photosensitive member 10 or the single-layer electrophotographic photosensitive member 20) according to the present embodiment.

The amounts of the charge generating material, the binder resin, the charge transport material, the silica fine particles, and the electron acceptor compound contained in the single-layer electrophotographic photosensitive member 20 are not particularly limited. For example, the charge generating material is preferably contained in an amount of no less than 0.1 parts by mass and no greater than 50 parts by mass, more preferably in an amount of no less than 0.2 parts by mass and no greater than 40 parts by mass, and still more preferably in an amount of no less than 0.5 parts by mass and no greater than 30 parts by mass relative to 100 parts by mass of the binder resin. A styryltriarylamine derivative is preferably contained as the charge transport material in an amount of no less than 30 parts by mass and no greater than 60 parts by mass relative to 100 parts by mass of the binder resin.

The electron acceptor compound is preferably contained in an amount of no less than 0.1 parts by mass and no greater than 100 parts by mass relative to 100 parts by mass of the binder resin. For example, the electron acceptor compound is preferably contained in an amount of no less than 10 parts by mass and no greater than 20 parts by mass relative to 100 parts by mass of the binder resin.

The silica fine particles are preferably contained in an amount of no less than 0.5 parts by mass and no greater than 15 parts by mass relative to 100 parts by mass of the binder resin.

### <Common Components>

Hereinafter, constituent elements of the single-layer electrophotographic photosensitive member and the multi-layer electrophotographic photosensitive member, and components contained in the single-layer electrophotographic photosensitive member and the multi-layer electrophotographic photosensitive member will be described in detail.

### [Substrate]

In the present embodiment, the substrate is not particularly limited so long as at least a surface portion thereof has conductivity. Specifically, the substrate may be made from a conductive material. Alternatively, the substrate may be made from a plastic material or glass whose surface has a coat or a deposit of a conductive material. Examples of the conductive material include metals such as aluminum, iron, copper, tin, platinum, silver, vanadium, molybdenum, chromium, cadmium, titanium, nickel, palladium, indium, stainless steel, and brass; and alloys of these metals. Alternatively, a glass substrate covered by aluminum iodide, alumite, tin oxide, indium oxide, or the like may be used. One of the conductive materials may be used independently, or two or more of the conductive materials may be used in combination.

Of the substrates mentioned as examples above, a substrate containing aluminum or an aluminum alloy is preferably used. This is because the use of such a substrate improves charge transfer from the photosensitive layer to the substrate, and therefore provides a photosensitive member capable of forming images having better quality.

The shape of the substrate is not particularly limited and may be selected as appropriate. For example, the substrate may take the form of a sheet or drum depending on the structure of the image forming apparatus to which the conductive substrate is applied. Desirably, the substrate has mechanical strength sufficient for use.

### [Charge Generating Material]

The charge generating material is not particularly limited so long as it is a charge generating material for electrophotographic photosensitive members. Examples of the charge generating material include: X-form metal-free phthalocyanine (x-H₂Pc); Y-form titanyl phthalocyanine (Y—TiOPc); perylene pigments; bis-azo pigments; dithioketopyrrolopyrrole pigments; metal-free naphthalocyanine pigments; metal naphthalocyanine pigments; squaraine pigments; tris-azo pigments; indigo pigments; azulenium pigments; cyanine pigments; powders of inorganic photoconductive materials such as selenium, selenium-tellurium, selenium-arsenic, cadmium sulfide, and amorphous silicon; pyrylium salts; anthanthrone-based pigments; triphenylmethane-based pigments; threne-based pigments; toluidine-based pigments; pyrazoline-based pigments; and quinacridone-based pigments.

A charge generating material having an absorption wavelength within a desired range may be used independently, or two or more charge generating materials may be used in combination. Furthermore, image forming apparatuses employing a digital optical system (e.g., laser beam printers and facsimile machines each employing a semiconductor laser or the like as a light source) preferably include a photosensitive member having a sensitivity in a wavelength range of no less than 700 nm, for example. Therefore, a phthalocyanine-based pigment (e.g., X-form metal-free phthalocyanine (x-H₂Pc) or a Y-form titanyl phthalocyanine (Y—TiOPc)) is suitably used, for example. The crystal form of the phthalocyanine-based pigment is not particularly limited, and various crystal forms of phthalocyanine-based pigments may be used.

An anthanthrone-based pigment or a perylene-based pigment is suitably used as a charge generating material in the photosensitive member used in an image forming apparatus employing a short-wavelength laser light source (e.g., a laser light source having a wavelength of approximately 350 nm to 550 nm).

The charge generating material is for example any of phthalocyanine-based pigments CGM-1 to CGM-4 represented by the following formulae (2) to (5), respectively.

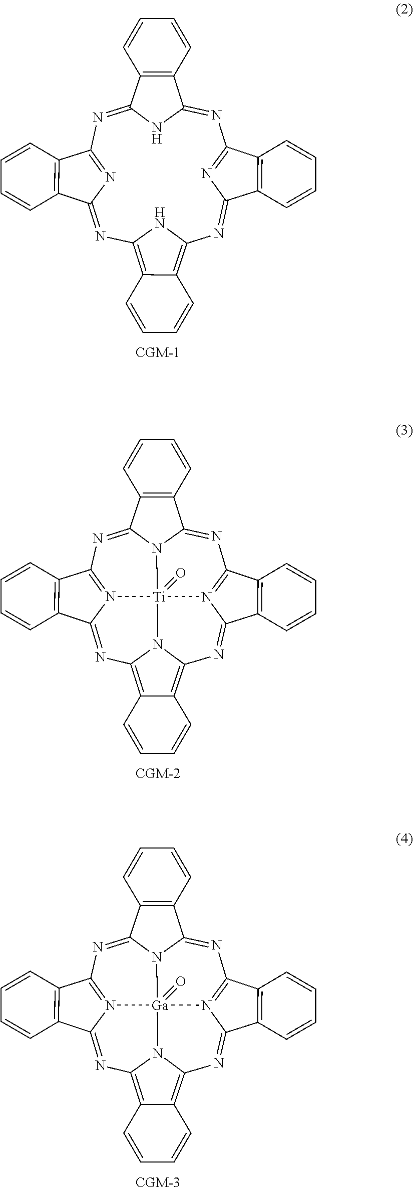

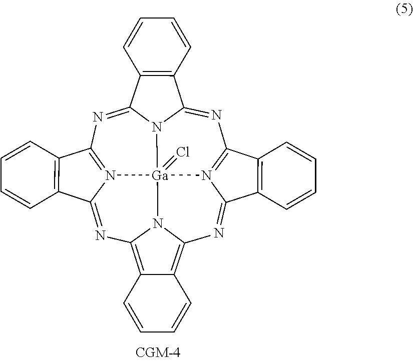

In the multi-layer electrophotographic photosensitive member, the charge generating material is preferably contained in an amount of no less than 5 parts by mass and no greater than 1,000 parts by mass, and more preferably in an amount of no less than 30 parts by mass and no greater than 500 parts by mass relative to 100 parts by mass of the base resin contained in the charge generating layer 13. The base resin will be described later.

In the single-layer electrophotographic photosensitive member, the charge generating material is preferably contained in an amount of no less than 0.1 parts by mass and no greater than 50 parts by mass, and more preferably in an amount of no less than 0.5 parts by mass and no greater than 30 parts by mass relative to 100 parts by mass of the binder resin.

### [Charge Transport Material]

In the present embodiment, the photosensitive layer contains a charge transport material. In particular, the charge transport material is a hole transport material.

### (Hole Transport Material)

The hole transport material used in the present embodiment preferably contains a compound having two or more styryl groups and one or more aryl groups. Specifically, the hole transport material preferably contains a compound represented by any of the following formulae (6) to (9).

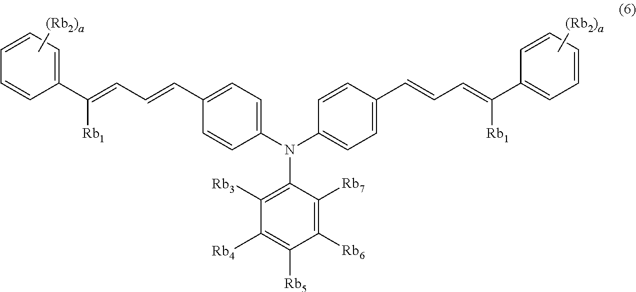

In the formula (6), Rb₁ to Rb₇ each independently represent a hydrogen atom, an alkyl group having 1 to 8 carbon atoms, a phenyl group, or an alkoxy group. The letter a represents an integer from 0 to 5. Adjacent groups out of Rb₃ to Rb₇ may be bound to each other to form a ring. For example, any adjacent two of Rb₃ to Rb₇ may form an alkyl ring having 4 to 6 carbon atoms or a benzene ring.

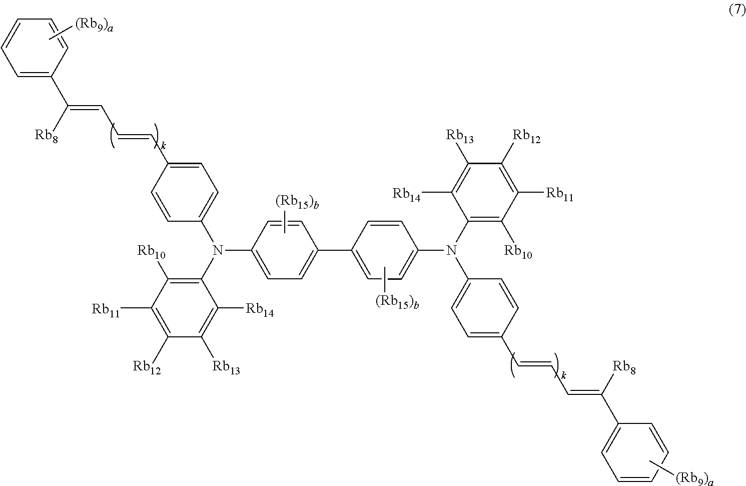

In the formula (7), Rb₈ to Rb₁₅ each independently represent a hydrogen atom, an alkyl group having 1 to 8 carbon atoms, a phenyl group, or an alkoxy group. The letter a represents an integer from 0 to 5. The letter b represents an integer from 0 to 4. The letter k represents an integer of 0 or 1. Adjacent groups out of Rb₁₀ to Rb₁₄ may be bound to each other to form a ring. For example, any adjacent two of Rb₁₀ to Rb₁₄ may form an alkyl ring having 4 to 6 carbon atoms or a benzene ring.

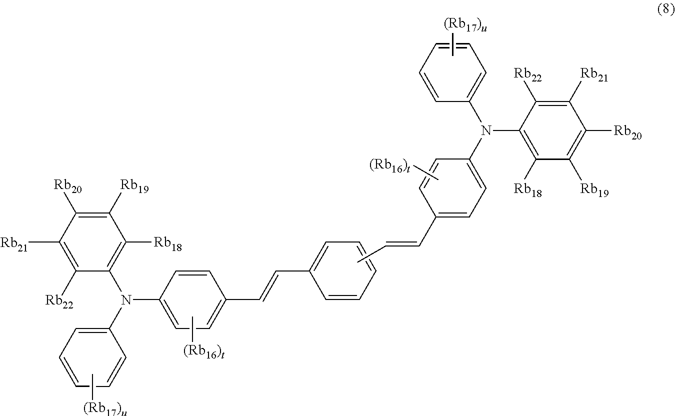

In the formula (8), Rb₁₆ to Rb₂₂ each independently represent an alkyl group having 1 to 8 carbon atoms, a phenyl group, or an alkoxy group. The letter t represents an integer from 0 to 4. The letter u represents an integer from 0 to 5.

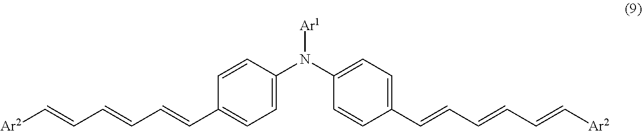

In the formula (9), Ar¹ represents an aryl group or a heterocyclic group having conjugated double bonds. Ar² is an aryl group. Ar¹ and Ar² may each independently be substituted with one or more groups selected from the group consisting of an alkyl group having 1 to 6 carbon atoms, an alkoxy group, and a phenoxy group.

The styryltriarylamine derivative is selectively compatible with the polycarbonate resin. A photosensitive member containing the styryltriarylamine derivative and the polycarbonate resin therefore has excellent ozone resistance and abrasion resistance while maintaining excellent electrical characteristics.

An additional hole transport material different from the styryltriarylamine derivative may be contained.

Representative examples of the hole transport material include nitrogen-containing cyclic compounds and condensed polycyclic compounds. Examples of the nitrogen-containing cyclic compounds and the condensed polycyclic compounds include styryltriarylamine-based compounds (other than the styryltriarylamine derivative), oxadiazole-based compounds (e.g., 2,5-di(4-methylaminophenyl)-1,3,4-oxadiazole), styryl-based compounds (e.g., 9-(4-diethylaminostyryl)anthracene), carbazole-based compounds (e.g., polyvinyl carbazole), organic polysilane compounds, pyrazoline-based compound (e.g., 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds. One of the hole transport materials may be used independently, or two or more of the hole transport materials may be used in combination.

When the additional hole transport material different from the styryltriarylamine derivative is contained as described above, the additional hole transport material is preferably contained in an amount of no less than 1 part by mass and no greater than 100 parts by mass relative to 100 parts by mass of the binder resin.

Specifically, the hole transport material is any of CTM-1 to CTM-12 represented by the following formulae (10) to (21), respectively. It should be note that CTM-1 to CTM-4 are specific examples of the hole transport material represented by the formula (6). CTM-5 to CTM-7 are specific examples of the hole transport material represented by the formula (7). CTM-8 and CTM-9 are specific examples of the hole transport material represented by the formula (8). CTM-10 is a specific example of the hole transport material represented by the formula (9).

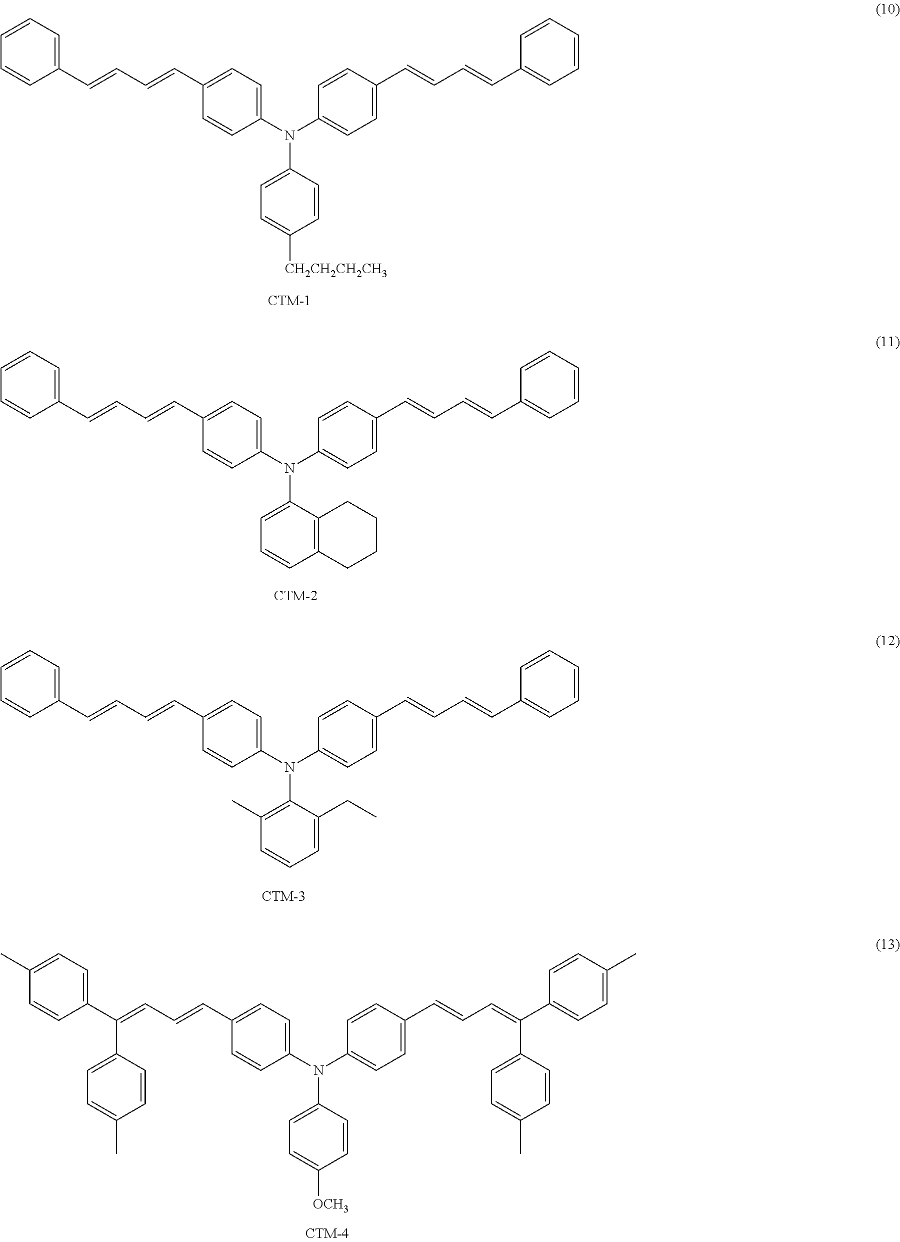

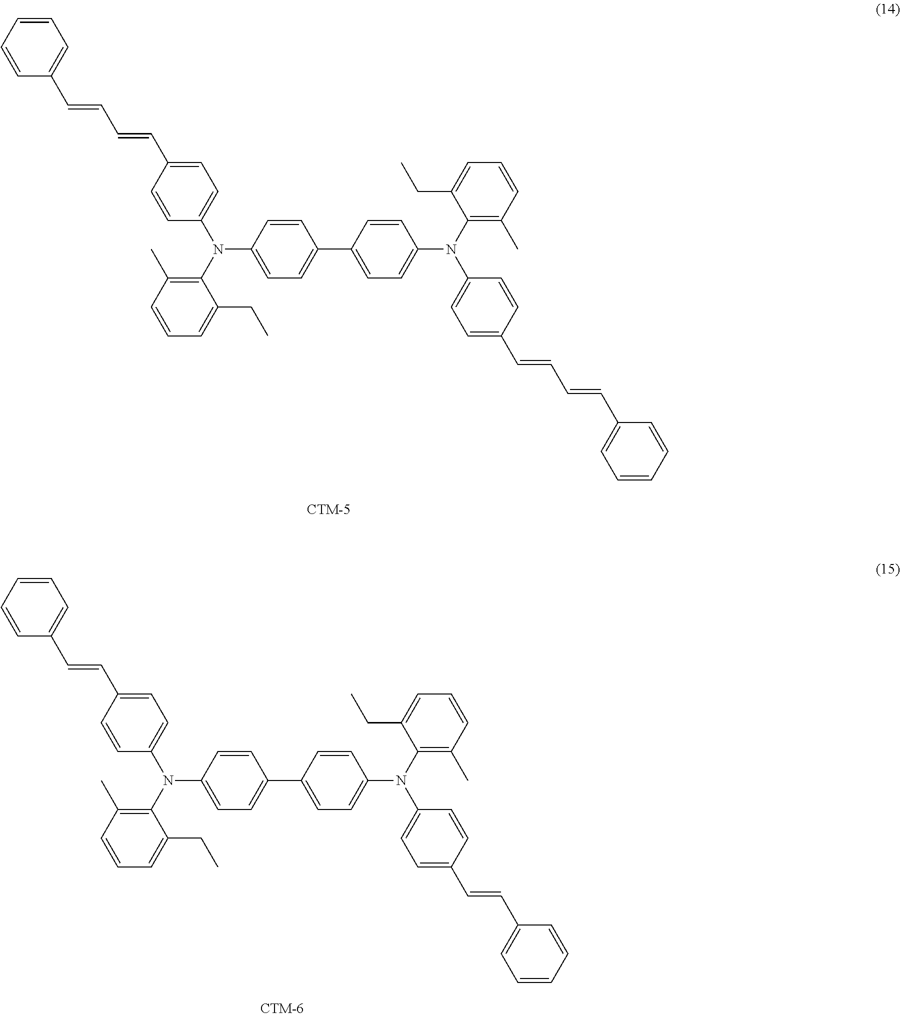 [SMILES: CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1]

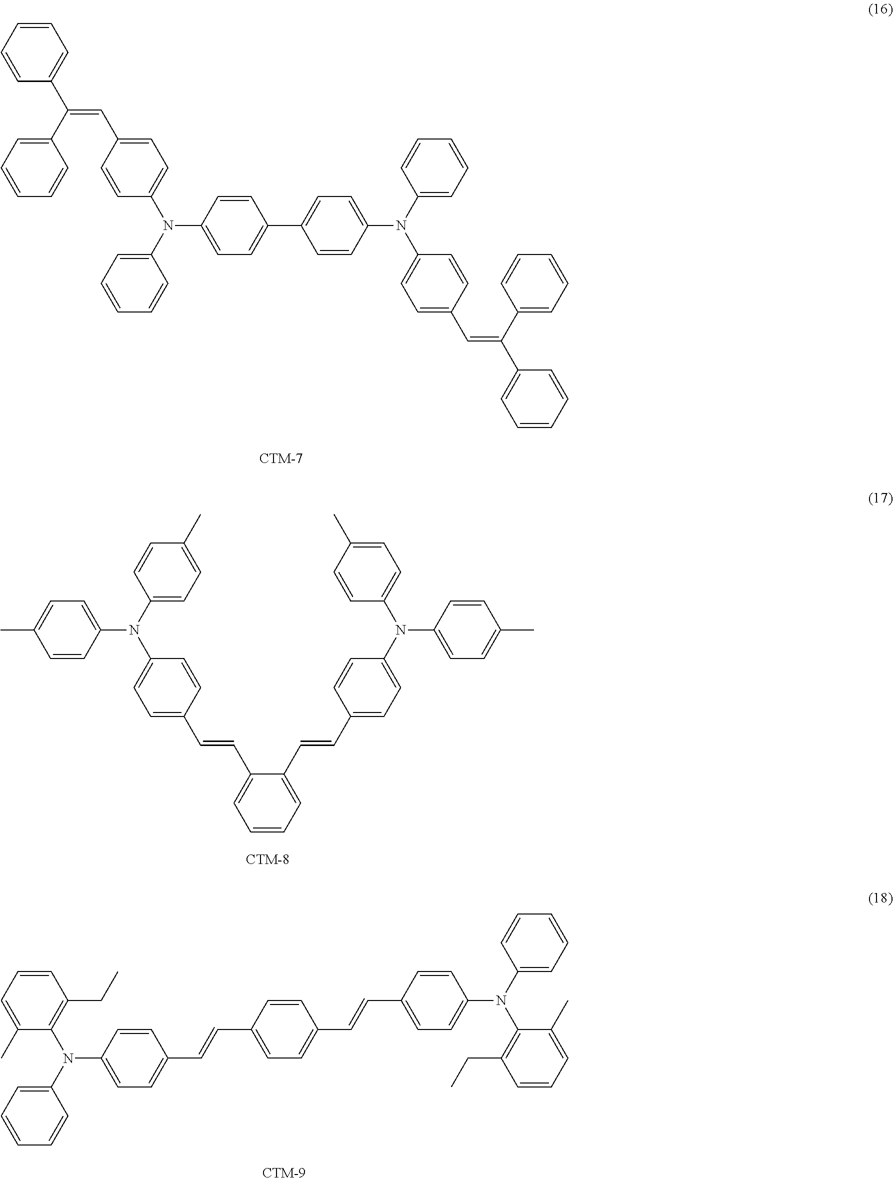

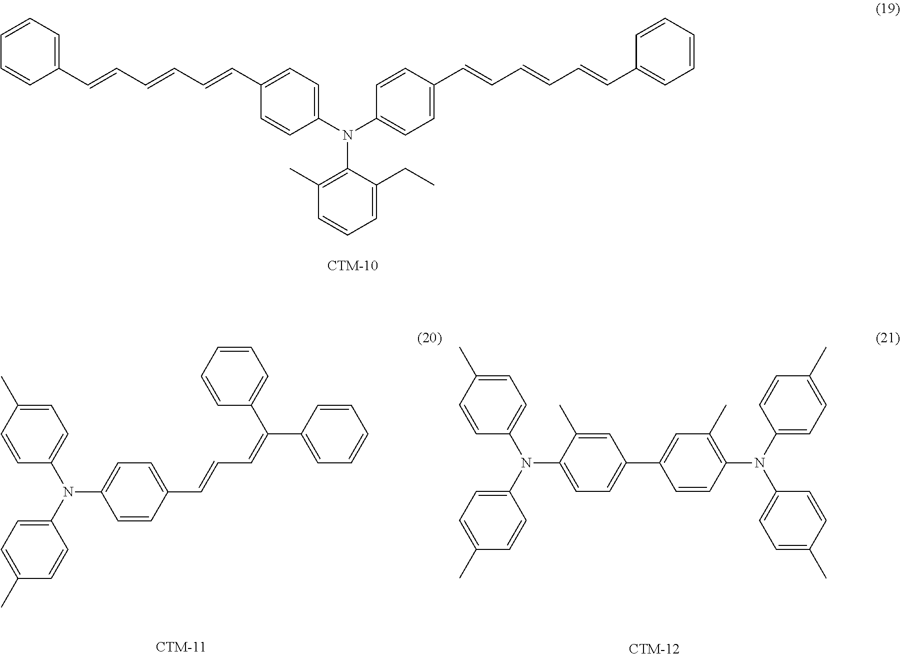 [SMILES: CCc1cccc(C)c1N(c1ccc(/C=C/C=C/C=C/c2ccccc2)cc1)c1ccc(/C=C/C=C/C=C/c2ccccc2)cc1 ; Cc1ccc(N(c2ccc(C)cc2)c2ccc(/C=C/C=C(c3ccccc3)c3ccccc3)cc2)cc1 ; Cc1ccc(N(c2ccc(C)cc2)c2ccc(-c3ccc(N(c4ccc(C)cc4)c4ccc(C)cc4)c(C)c3)cc2C)cc1]

In the multi-layer electrophotographic photosensitive member, the hole transport material (charge transport material) is preferably contained in an amount of no less than 10 parts by mass and no greater than 200 parts by mass, and more preferably in an amount of no less than 20 parts by mass and no greater than 100 parts by mass relative to 100 parts by mass of the binder resin. In the single-layer electrophotographic photosensitive member, the hole transport material (charge transport material) is preferably contained in an amount of no less than 10 parts by mass and no greater than 200 parts by mass, and more preferably in an amount of no less than 10 parts by mass and no greater than 100 parts by mass relative to 100 parts by mass of the binder resin.

### [Electron Acceptor Compound]

The photosensitive layer may contain an electron acceptor compound as needed. When containing an electron acceptor compound, in particular, the single-layer photosensitive layer of the single-layer electrophotographic photosensitive member is capable of electron transfer. Thus, the single-layer photosensitive layer can be bipolar. When containing an electron acceptor compound, the multi-layer photosensitive layer of the multi-layer electrophotographic photosensitive member can be improved in the hole transport ability of the hole transport material.

Examples of the electron acceptor compound include quinone-based compounds (naphthoquinone-based compounds, diphenoquinone-based compounds, anthraquinone-based compounds, azoquinone-based compounds, nitroanthraquinone-based compounds, and dinitroanthraquinone-based compounds), malononitrile-based compounds, thiopyran-based compounds, trinitrothioxanthone-based compounds, 3,4,5,7-tetranitro-9-fluorenone-based compounds, dinitroanthracene-based compounds, dinitroacridine-based compounds, tetracyanoethylene, 2,4,8-trinitrothioxanthone, dinitrobenzene, dinitroanthracene, dinitroacridine, succinic anhydride, maleic anhydride, and dibromomaleic anhydride. One of these electron acceptor compounds may be used independently, or two or more of the electron acceptor compounds may be used in combination.

In the case where such an electron acceptor compound is contained, the electron acceptor compound is preferably contained in an amount of no less than 0.1 parts by mass and no greater than 20 parts by mass relative to 100 parts by mass of the binder resin.

The electron acceptor compound is for example any of ETM-1 to ETM-8 represented by the following formulae (22) to (29), respectively.

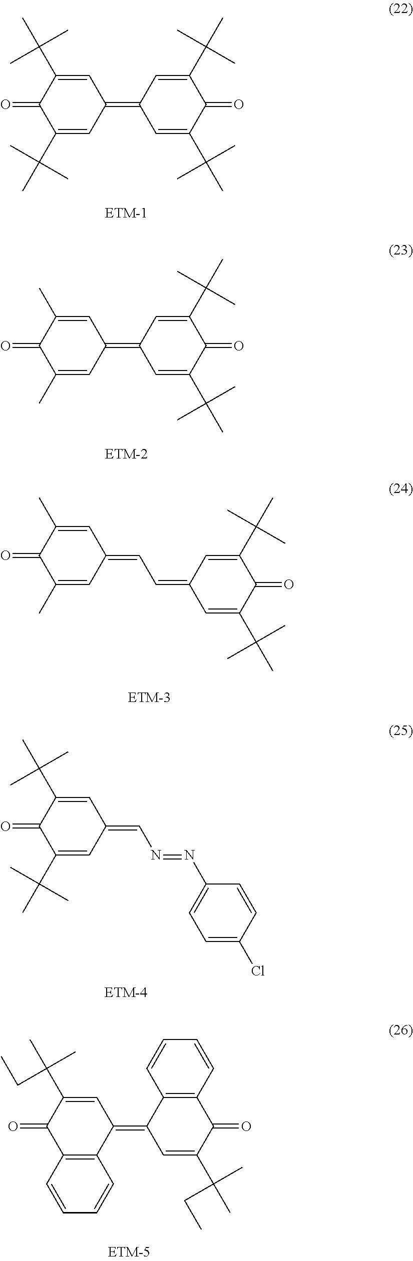 [SMILES: CC(C)(C)C1=CC(=C2C=C(C(C)(C)C)C(=O)C(C(C)(C)C)=C2)C=C(C(C)(C)C)C1=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O ; CC(C)(C)C1=CC(=C/N=N/c2ccc(Cl)cc2)C=C(C(C)(C)C)C1=O ; CCC(C)(C)C1=C/C(=C2/C=C(C(C)(C)CC)C(=O)c3ccccc32)c2ccccc2C1=O]

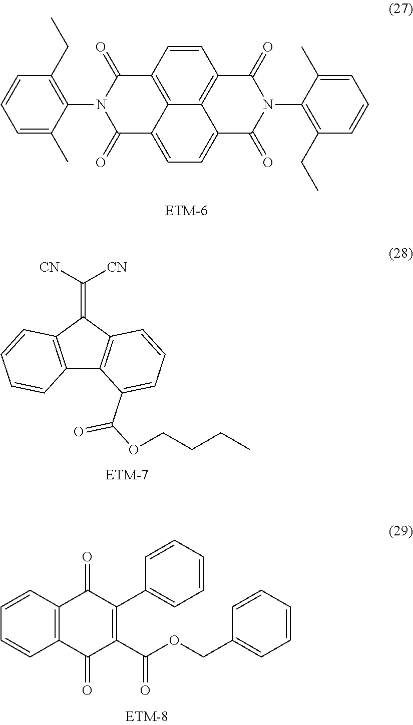

In the multi-layer electrophotographic photosensitive member, the electron acceptor compound is preferably contained in an amount of no less than 0.1 parts by mass and no greater than 20 parts by mass, and more preferably in an amount of no less than 0.5 parts by mass and no greater than 10 parts by mass relative to 100 parts by mass of the binder resin. In the single-layer electrophotographic photosensitive member, the electron acceptor compound is preferably contained in an amount of no less than 5 parts by mass and no greater than 100 parts by mass, and more preferably in an amount of no less than 10 parts by mass and no greater than 80 parts by mass relative to 100 parts by mass of the binder resin.

### [Resins]

### (Base Resin)

The charge generating layer contained in the multi-layer photosensitive layer contains a base resin (base resin for charge generating layer formation).

The base resin for charge generating layer formation is not particularly limited so long as it is a resin usable for charge generating layers of multi-layer electrophotographic photosensitive members.

Typically, multi-layer electrophotographic photosensitive member includes the charge generating layer and the charge transport layer. In the multi-layer electrophotographic photosensitive member, therefore, the base resin for charge generating layer formation is preferably a different resin from the binder resin in order to prevent the base resin from being dissolved in a solvent used for the application liquid for the formation of the charge transport layer.

Specific examples of the base resin for charge generating layer formation include styrene-butadiene copolymers, styrene-acrylonitrile copolymers, styrene-maleic acid copolymers, acrylic copolymers, styrene-acrylic acid copolymers, polyethylene resins, ethylene-vinyl acetate copolymers, chlorinated polyethylene resins, polyvinyl chloride resins, polypropylene resins, ionomer resins, vinyl chloride-vinyl acetate copolymers, alkyd resins, polyamide resins, polyurethane resins, polysulfone resins, diallyl phthalate resins, ketone resins, polyvinyl acetal resins, polyvinyl butyral resins, polyether resins, silicone resins, epoxy resins, phenolic resins, urea resins, melamine resins, epoxy acrylate resins, and urethane-acrylate resin. Polyvinyl butyral is suitably used as the base resin for charge generating layer formation. One of the base resins for charge generating layer formation may be used independently, or two or more of the base resins may be used in combination.

### (Binder Resin)

The binder resin is used in the single-layer photosensitive layer of the single-layer electrophotographic photosensitive member or in the charge transport layer of the multi-layer electrophotographic photosensitive member. The binder resin contains a polycarbonate resin represented by the general formula (1a). The polycarbonate resin represented by the general formula (1a) is a polycarbonate copolymer including a repeating structural unit represented by the formula (1a-1) and a repeating structural unit represented by the formula (1a-2).

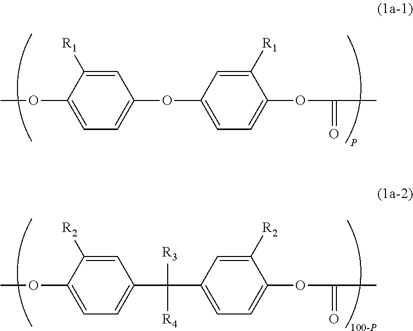

In the general formula (1a), P is greater than 0 and no greater than 100. Preferably, P is no less than 25 and no greater than 70. The use of such a polycarbonate resin as the binder resin provides an electrophotographic photosensitive member including a photosensitive layer having excellent abrasion resistance and oil cracking resistance.

When P is no less than 25, the photosensitive layer has improved abrasion resistance. Considering other properties of the photosensitive layer or the electrophotographic photosensitive member (e.g., electrical characteristics or oil cracking resistance), in particular, it is more preferable that P is no less than 25 and no greater than 70.

In the repeating units represented by the formulae (1a-1) and (1a-2), at least one of R₁ to R₄ is preferably an alkyl group having 1 to 4 carbon atoms. More preferably, any one of R₁ to R₄ is a methyl group.

A reason therefor is as follows. That is, when one of R₁ to R₄ is an alkyl group, the solubility of the binder resin to the solvent in the preparation of the photosensitive layer and the compatibility of the binder resin to the hole transport material are improved. As a result, an electrophotographic photosensitive member can be obtained that includes a photosensitive layer having satisfactory electrical characteristics and abrasion resistance.

Meanwhile, entanglement between polymer molecules of the polycarbonate resin tends to decrease, and thus the packing property of the molecules tends to degrade with excessive increase in chain length, branching, and number of alkyl groups in the polycarbonate resin. Thus, the use of the polycarbonate resin in the photosensitive layer may have adverse impact on the abrasion resistance. The photosensitive member or the photosensitive layer can be given excellent electrical characteristics and abrasion resistance through substitution with an alkyl group having a chain length (a chain length with 1 to 4 carbon atoms) suitable for the aromatic ring of the repeating unit in the polycarbonate resin.

There may be a quaternary carbon between the two phenylene groups in the repeating unit represented by the formula (1a-2). When the quaternary carbon is substituted with an alkyl group, the polycarbonate resin has a relatively low polarity portion in each repeating structural unit compared with a polycarbonate resin having a repeating unit including a secondary carbon. Consequently, the hole transport material tends to gather around each repeating structural unit of the polycarbonate resin represented by the general formula (1a). As a result, the dispersibility of the hole transport material in the charge transport layer or in the single-layer photosensitive layer increases, providing stable photosensitivity.

The viscosity average molecular weight of the binder resin (including the polycarbonate resin represented by the general formula (1a)) is preferably no less than 40,000, and more preferably no less than 40,000 and no greater than 52,500. If the molecular weight of the binder resin is too low, the abrasion resistance of the binder resin cannot be sufficiently high. As a result, the charge transport layer or the single-layer photosensitive layer is prone to abrasion. If the molecular weight of the binder resin is too high, the binder resin is less soluble in the solvent in the formation of the charge transport layer or the single-layer photosensitive layer, which is likely to make it difficult to form the charge transport layer or the single-layer photosensitive layer.

The polycarbonate resin may for example have a structure of a random copolymer in which the repeating structural unit represented by the formula (1a-1) and the repeating structural unit represented by the formula (1a-2) are copolymerized in a random order. Alternatively, the polycarbonate resin may be for example an alternating copolymer in which the repeating structural unit represented by the formula (1a-1) and the repeating structural unit represented by the formula (1a-2) are copolymerized alternately. Alternatively, the polycarbonate resin may be a periodic copolymer in which one or more repeating structural units each represented by the formula (1a-1) and one or more repeating structural units each represented by the formula (1a-2) are copolymerized in a repeating sequence. Alternatively, the polycarbonate resin may be a block copolymer in which a block of a plurality of repeating structural units each represented by the formula (1a-1) and a block of a plurality of repeating structural units each represented by the formula (1a-2) are arranged.

Examples of the method of preparing the binder resin include a method involving interfacial polycondensation between phosgene and a diol compound for forming a repeating structural unit of the polycarbonate resin (so-called phosgene method) and a method involving an ester exchange reaction of a diol compound with diphenyl carbonate. More specifically, may be mentioned for example a method involving interfacial polycondensation between phosgene and a mixture obtained by mixing a diol compound represented by the following formula (1a-3) and a diol compound represented by the following formula (1a-4) in a manner that the diol compound represented by the formula (1a-3) is introduced.

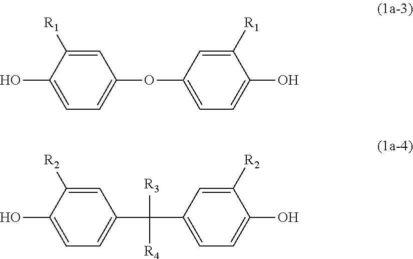

The polycarbonate resin represented by the general formula (1a) is for example any of Resin-1 to Resin-7 represented by the following formulae (30) to (36), respectively. Each of the subscripts in the formulae (30) to (36) represents the proportion of a repeating structural unit in the corresponding polycarbonate resin.

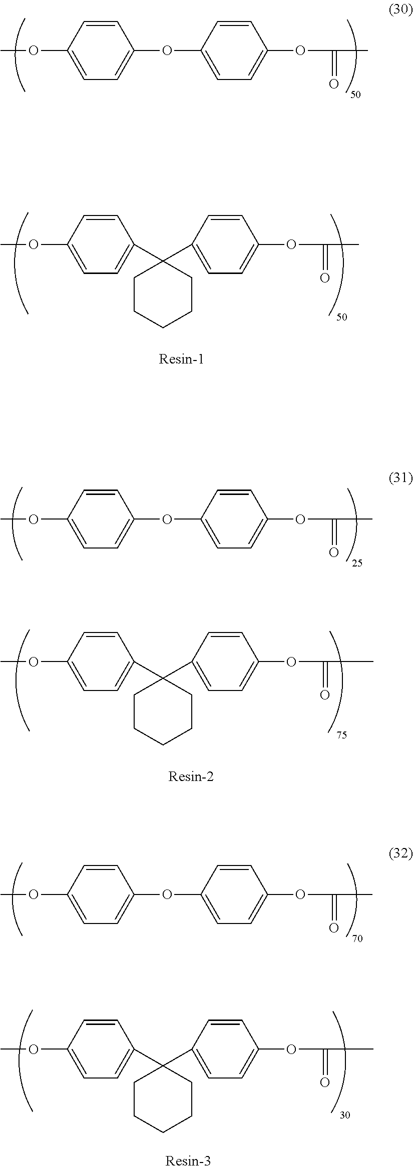

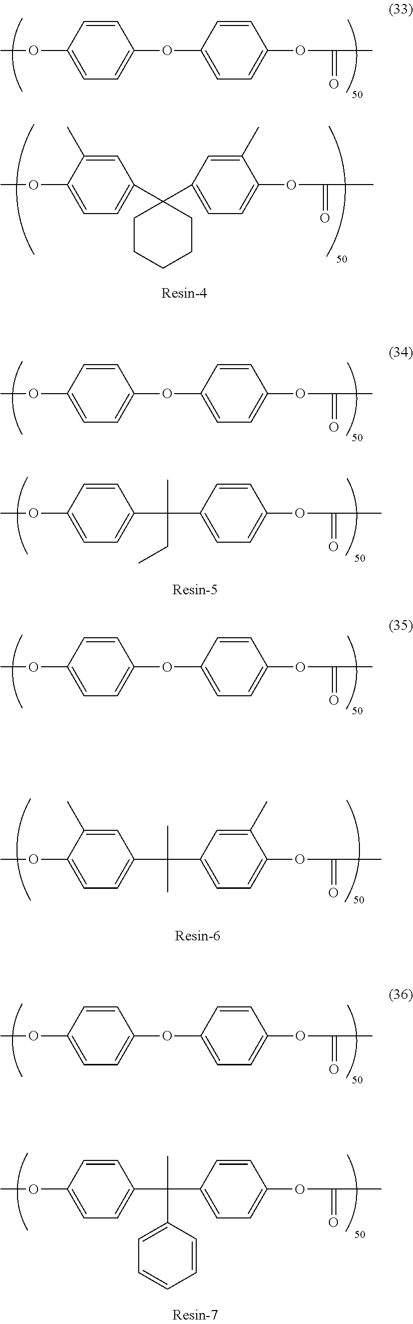

As the binder resin in the present embodiment, the polycarbonate resin represented by the general formula (1a) may be used independently, or a resin (additional resin) other than the polycarbonate resin represented by the general formula (1a) may be used so long as the effect of the present disclosure is not impaired. Examples of the additional resin include thermoplastic resins (polycarbonate resins other than the polycarbonate resin represented by the general formula (1a), styrene-based resins, styrene-butadiene copolymers, styrene-acrylonitrile copolymers, styrene-maleic acid copolymers, styrene-acrylic acid copolymers, acrylic copolymers, polyethylene resins, ethylene-vinyl acetate copolymers, chlorinated polyethylene resins, polyvinyl chloride resins, polypropylene resins, ionomer, vinyl chloride-vinyl acetate copolymers, polyester resins, alkyd resins, polyamide resins, polyurethane resins, polyarylate resins, polysulfone resins, diallyl phthalate resins, ketone resins, polyvinyl butyral resins, and polyether resins), thermosetting resins (silicone resins, epoxy resins, phenolic resins, urea resins, melamine resins, and other crosslinkable thermosetting resins), and photocurable resins (epoxy acrylate resins and urethane-acrylate copolymer resins). One of the resins may be used independently, or two or more of the resins may be used in combination.

In the present embodiment, the polycarbonate resin preferably constitutes 40% by mass or more of the binder resin, and more preferably 80% by mass or more of the binder resin.

Alternatively, the binder resin may include a polycarbonate resin having a structural unit represented by the general formula general formula (1b).

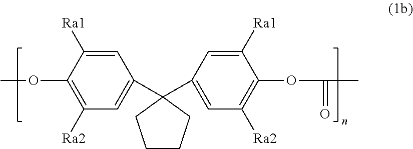

In the general formula (1b), Ra₁ and Ra₂ each independently represent a hydrogen atom or an alkyl group having 1 to 3 carbon atoms.

The polycarbonate resin represented by the general formula (1b) is for example any of Resin-8 to Resin-13 represented by the following formulae (37) to (42), respectively. Each of the subscripts in the formulae (37) to (42) represents the proportion of a repeating structural unit in the corresponding polycarbonate resin.

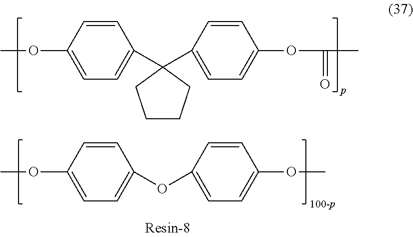

P is greater than 0 and no greater than 100.

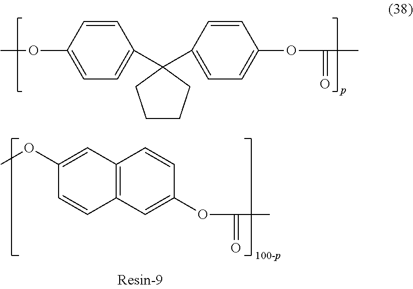

P is greater than 0 and no greater than 100.

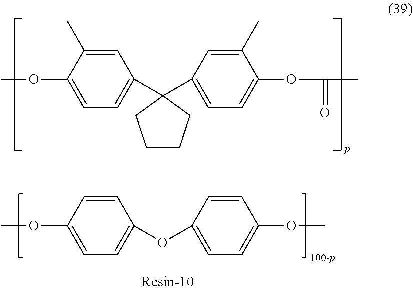

P is greater than 0 and no greater than 100.

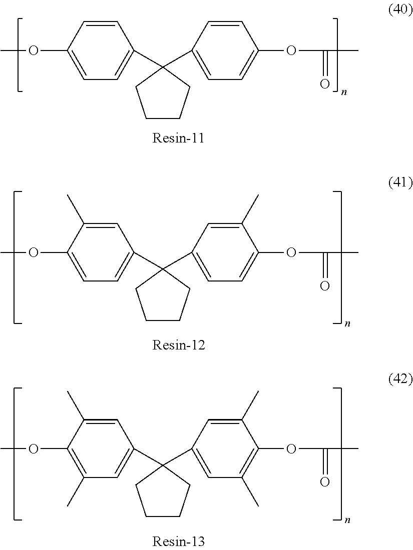

Furthermore, a polycarbonate resin having a copolymer structure of the structural unit represented by the general formula (1b) and a structural unit represented by the general formula (43) or the general formula (44) may be used as the binder resin.

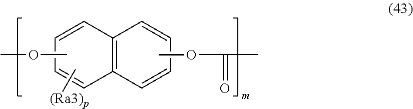

In the general formula (43), Ra₃ represents a hydrogen atom, an alkyl group having 1 to 3 carbon atoms, a fluoroalkyl group, a halogen atom, or a phenyl group, and p is an integer from 1 to 8. The letter m represents a degree of polymerization. The value of m in the general formula (43) may be equal to or different from the value of n in the general formula (1b).

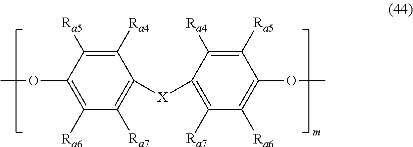

X in the general formula (44) represents a single bond, —O—, —S—, —CO—, —COO—, —(CH₂)₂—, —SO—, —SO₂—, —CRa₈Ra₉—, —SiRa₈Ra₉—, or —SiRa₈Ra₉-O—. Ra₈ and Ra₉ independently represent a hydrogen atom, an alkyl group having 1 to 8 carbon atoms, a substituted or unsubstituted aryl group, or a trifluoromethyl group. Ra₈ and Ra₉ may independently be an alkyl ring having 2 to 4 carbon atoms or a benzene ring. Ra₈ and Ra₉ may be joined together to form a cycloalkylidene group optionally having a substituent having 5 to 12 carbon atoms. Ra₄ to Ra₇ in the general formula (44) each independently represent a hydrogen atom, an alkyl group having 1 to 3 carbon atoms, a fluoroalkyl group, a halogen atom, or a phenyl group. The letter m represents a degree of polymerization. The value of m in the general formula (44) may be equal to or different from the value of n in the general formula (1b).

The binder resin may have a copolymer structure including only the structural unit represented by the general formula (1b) and the structural unit represented by the general formula (43). P is greater than 0 and no greater than 100, wherein the proportion of the structural unit represented by the general formula (1b) is P, and the proportion of the structural unit represented by the general formula (43) is 100-P among the repeating structural units in the polycarbonate resin.

Alternatively, the binder resin may have a copolymer structure including only the structural unit represented by the general formula (1b) and the structural unit represented by the general formula (44). P is greater than 0 and no greater than 100, wherein the proportion of the structural unit represented by the general formula (1b) is P and the proportion of the structural unit represented by the general formula (44) is 100-P among the repeating structural units in the polycarbonate resin.

A resin different from the above-described resin may be additionally used as the binder resin in the charge transport layer 14. Examples of the binder resin include thermoplastic resins (e.g., polycarbonate resins other than the polycarbonate resin specified above, polyester resins, polyarylate resins, styrene-butadiene copolymer resins, styrene-acrylonitrile copolymer resins, styrene-maleic acid copolymer resins, acrylic copolymer resins, styrene-acrylic acid copolymer resins, polyethylene resins, ethylene-vinyl acetate copolymer resins, chlorinated polyethylene resins, polyvinyl chloride resins, polypropylene resins, ionomer resins, vinyl chloride-vinyl acetate copolymers, alkyd resins, polyamide resins, polyurethane resins, polysulfone resins, diallyl phthalate resins, ketone resins, polyvinyl butyral resins, and polyether resins), thermosetting resins (e.g., silicone resins, epoxy resins, phenolic resins, urea resins, and melamine resins), and photocurable resins (e.g., epoxy acrylate resins and urethane-acrylate resins). One of the binder resins may be used independently, or two or more of the binder resins may be used in combination.

The binder resin preferably has a viscosity average molecular weight of no less than 40,000, and more preferably no less than 40,000 and no greater than 60,000. If the binder resin has a too low viscosity average molecular weight, the abrasion resistance of the binder resin cannot be enhanced, and therefore the resulting charge transport layer is susceptible to abrasion. If the binder resin has a too high viscosity average molecular weight, the binder resin is less soluble in non-halogenated polar mixed solvents and non-halogenated non-polar mixed solvents, making it difficult to prepare an application liquid for charge transport layer. As a result, a favorable charge transport layer cannot be formed.

The polycarbonate resin preferably constitutes no less than 40% by mass, and more preferably 100% by mass of the binder resin.

### [Silica Particles]

In the electrophotographic photosensitive member of the present embodiment, the charge transport layer of the multi-layer photosensitive layer and the single-layer photosensitive layer contain silica particles for improvement in abrasion resistance and/or crack resistance of the photosensitive layer. That is, the outermost layer of the photosensitive layer contains silica fine particles. In the present embodiment, the silica particles particularly refer to silica fine particles. The silica fine particles can improve the abrasion resistance and the oil cracking resistance of the photosensitive layer better than non-silica fine particles (e.g., zinc oxide, titanium oxide, tin oxide, antimony oxide, indium oxide, bismuth oxide, tin-doped indium oxide, antimony- or tantalum-doped tin oxide, or zirconium oxide) can. The silica fine particles further have advantages of ease of surface treatment, less cost, and ease of adjustment of the particle diameter.

The silica fine particles are preferably those surface-treated with a surface treatment agent in order to improve the abrasion resistance of the photosensitive layer. Examples of surface treatment agents include hexamethyldisilazane, N-methyl-hex amethyldisilazane, N-ethyl-hexamethyldisilazane, hexamethyl-N-propyldisilazane, dimethyldichlorosilane, and polydimethylsiloxane. Particularly preferably, the surface treatment agent is hexamethyldisilazane for the following reason. That is, trimethylsilyl groups of the hexamethyldisilazane have good reactivity with hydroxyl groups of the surfaces of the silica fine particles, and thus the hydroxyl groups are reduced in the surfaces of the hexamethyldisilazane-treated silica fine particles. As a result, deterioration of the electrical characteristics of the electrophotographic photosensitive member due to moisture (humidity) can be restricted.

Furthermore, the use of hexamethyldisilazane as the surface treatment agent can ensure that liberation of the surface treatment agent from the surfaces of the silica fine particles is restricted. The liberated surface treatment agent may cause charge trapping, reducing the sensitivity of the electrophotographic photosensitive member. Since hexamethyldisilazane is used to restrict the liberation of the surface treatment agent from the surfaces of the silica fine particles in the present disclosure, the reduction of the sensitivity of the electrophotographic photosensitive member can be restricted sufficiently. Furthermore, the polycarbonate resin having a specified structure and the silica fine particles contained in the charge transport layer 14 can improve the abrasion resistance and electrical characteristics of the electrophotographic photosensitive member.

The silica fine particles are preferably contained in an amount of no less than 0.5 parts by mass and no greater than 15 parts by mass, and more preferably in an amount of no less than 1 part by mass and no greater than 10 parts by mass relative to 100 parts by mass of the binder resin in order to improve the abrasion resistance of the photosensitive layer. When the electrophotographic photosensitive member is the multi-layer electrophotographic photosensitive member, the charge transport layer included in the multi-layer photosensitive layer contains the silica fine particles. When the electrophotographic photosensitive member is the single-layer electrophotographic photosensitive member, the single-layer photosensitive layer contains the silica fine particles.

Preferably, the silica fine particles have a particle diameter (number average primary particle diameter) of no less than 7 nm and no greater than 50 nm. If the silica fine particles have a particle diameter of less than 7 nm, the resulting photosensitive layer may have poor abrasion resistance and oil cracking resistance. On the other hand, if the silica fine particles have a particle diameter of greater than 50 nm, the dispersibility of the silica fine particles in the binder resin may be reduced.

### [Additive]

In the present embodiment, at least one of the multi-layer photosensitive layer (the charge generating layer and the charge transport layer), the single-layer photosensitive layer, and the intermediate layer may contain one or more additives so long as the electrophotographic characteristics of the resulting electrophotographic photosensitive member is not adversely affected. Examples of the additives include antidegradants (antioxidants, radical scavengers, singlet quenchers, and ultraviolet absorbing agents), softeners, surface modifiers, extenders, thickeners, dispersion stabilizers, waxes, acceptors, donors, surfactants, and leveling agents.

The charge transport layer 14 may contain an antioxidant. Examples of the antioxidant include hindered phenol-based compounds, hindered amine-based compounds, thioether-based compounds, and phosphite-based compounds. Of the antioxidants, hindered phenol-based compounds or hindered amine-based compounds are preferable. Specific examples of the antioxidant include hindered phenol, hindered amine, paraphenylenediamine, arylalkane, hydroquinone, spirochromane, spiroindanone, and their derivatives as well as organosulfur compounds and organophosphorous compounds.

The antioxidant is preferably added to the charge transport layer 14 in an amount of no less than 0.1 parts by mass and no greater than 10 parts by mass relative to 100 parts by mass of the binder resin. The antioxidant added in an amount within the above-specified range can inhibit deterioration of electrical characteristics of the resulting electrophotographic photosensitive member due to oxidation of the electrophotographic photosensitive member. Preferably, the charge transport layer 14 has a film thickness of no less than 5 μm and no greater than 50 μm.

The charge generating layer or the single-layer photosensitive layer may contain a sensitizer (e.g., terphenyl, halonaphthoquinones, or acenaphthylene) as an additive in order to increase the sensitivity.

The charge transport layer or the single-layer photosensitive layer may contain a plasticizer as an additive in order to improve the oil cracking resistance. Examples of the plasticizer include biphenyl derivatives. The biphenyl derivatives are compounds represented by the following formulae (BP-1) to (BP-20), for example.

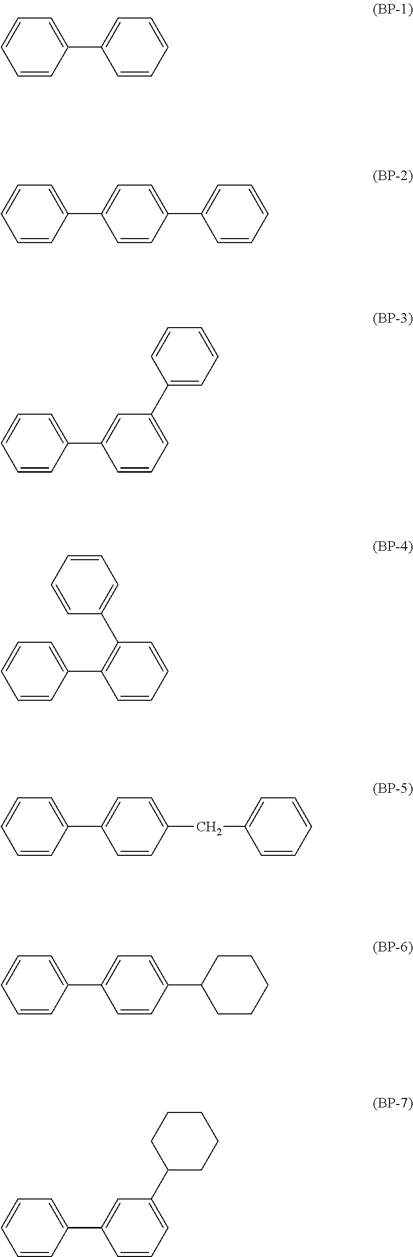

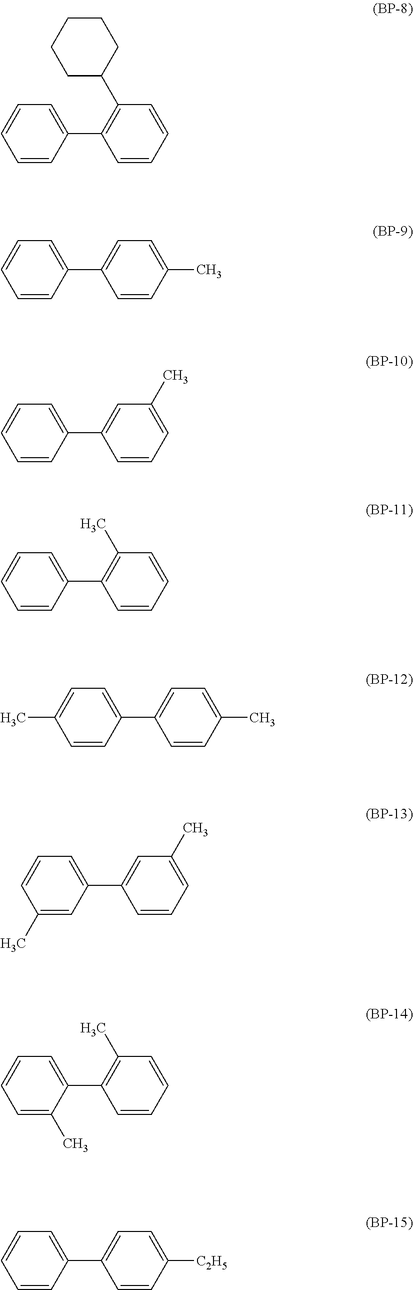

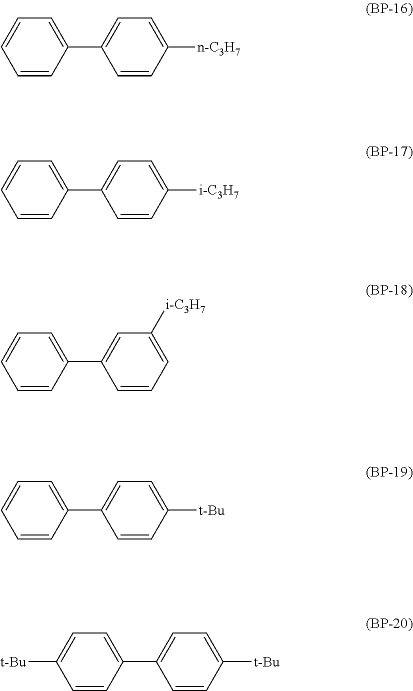

### [Intermediate Layer]

The electrophotographic photosensitive member according to the present embodiment may have an intermediate layer (e.g., undercoat layer). In the single-layer electrophotographic photosensitive member, the intermediate layer is located between the substrate and the photosensitive layer. In the multi-layer electrophotographic photosensitive member, the intermediate layer is located between the substrate and the charge generating layer. The intermediate layer contains inorganic particles and a resin usable for the intermediate layer (resin for the intermediate layer), for example. The presence of the intermediate layer allows electric current generated when the electrophotographic photosensitive member is exposed to light to flow smoothly to restrict increase in resistance while providing insulation enough to restrict leak current.

Examples of the inorganic particles include particles of metals (e.g., aluminum, iron, and copper), metal oxides (e.g., titanium oxide, alumina, zirconium oxide, tin oxide, and zinc oxide), and non-metal oxides (e.g., silica). One type of these inorganic particles may be used independently, or two or more types of these inorganic particles may be used in combination.

The resin for the intermediate layer is not particularly limited so long as it is a resin usable as a resin for forming the intermediate layer.

### <Method of Manufacturing Electrophotographic Photosensitive Member)

A method of manufacturing a single-layer electrophotographic photosensitive member will be described.

The single-layer electrophotographic photosensitive member is manufactured by applying an application liquid for single-layer photosensitive layer formation (first application liquid) onto a substrate and drying the same. The first application liquid is prepared by dissolving or dispersing, in a solvent, a charge generating material, a charge transport material (a hole transport material, an electron transport material), a binder resin, and silica fine particles, and as needed, an electron acceptor compound or one or more additives.

For example, an application liquid for photosensitive layer formation is prepared by mixing a charge generating material, a binder resin, a hole transport material, and silica fine particles in a solvent. The application liquid for photosensitive layer formation thus prepared is applied onto a conductive substrate by an application method. Thereafter, the liquid applied is dried with hot air to give the photosensitive layer 22 having a predetermined film thickness. The application liquid for photosensitive layer formation can be prepared, applied, and dried in the same manner as in preparation, application, and drying of an application liquid for charge generating layer formation for the charge generating layer 13 of the multi-layer electrophotographic photosensitive member 10.

A method of manufacturing a multi-layer electrophotographic photosensitive member will be described.

Specifically, an application liquid for charge generating layer formation (second application liquid) and an application liquid for charge transport layer formation (third application liquid) are prepared first. The second application liquid is applied onto a substrate and dried by an appropriate method to give a charge generating layer. Thereafter, the third application liquid is applied onto the charge generating layer and dried to give a charge transport layer. Thus, the multi-layer electrophotographic photosensitive member can be manufactured.

The second application liquid is prepared by dissolving or dispersing, in a solvent, a charge generating material, a base resin, and as needed, one or more additives. The third application liquid is prepared by dissolving or dispersing, in a solvent, a charge transport material, a binder resin, silica fine particles, and as needed, an electron acceptor compound and one or more additives.

The solvent contained in each application liquid (the first, second, or third application liquid) is not particularly limited so long as the components of the application liquid can be dissolved or dispersed therein. Specific examples of the solvent include alcohols (methanol, ethanol, isopropanol, and butanol), aliphatic hydrocarbons (n-hexane, octane, and cyclohexane), aromatic hydrocarbons (benzene, toluene, and xylene), halogenated hydrocarbons (dichloromethane, dichloroethane, chloroform, carbon tetrachloride, and chlorobenzene), ethers (dimethyl ether, diethyl ether, tetrahydrofuran, ethylene glycol dimethyl ether, diethylene glycol dimethyl ether, propylene glycol monomethyl ether, 1,3-dioxolane, and 1,4-dioxane), ketones (acetone, methyl ethyl ketone, and cyclohexane), esters (ethyl acetate and methyl acetate), dimethyl formaldehyde, dimethyl formamide, and dimethyl sulfoxide. One of the solvents may be used independently, or two or more of the solvents may be used in combination. In order to simplify the work of workers involved in the manufacturing of the photosensitive member, it is preferable to use a non-halogenated solvent as the solvent.

Each application liquid is prepared by mixing and dispersing its components in the solvent. The mixing or dispersing can be performed using, for example, a bead mill, a roll mill, a ball mill, an attritor, a paint shaker, or an ultrasonic disperser.

In order to improve the dispersibility of each component or the surface smoothness of each layer to be formed, a surfactant or a leveling agent may be contained in each application liquid, for example.

The method of applying each application liquid is not particularly limited so long as it is capable of applying the application liquid uniformly. Examples of the application method include dip coating, spray coating, spin coating, and bar coating.

The method of drying each application liquid is not particularly limited so long as it can vaporize the solvent in the application liquid. Examples of the drying method include a method involving a heat treatment (hot-air drying) using a high-temperature dryer or a vacuum dryer. The heat treatment is performed at a temperature of no less than 40° C. and no greater than 150° C. for 3 to 120 minutes, for example.

The electrophotographic photosensitive member of the present disclosure described above has excellent abrasion resistance and oil cracking resistance while maintaining excellent electrical characteristics, and therefore can be suitably applied to various image forming apparatuses.

### EXAMPLES

Hereinafter, the present disclosure will be described in more detail by way of examples. It should be noted that the present disclosure is in no way limited to the scope of the examples.

### Manufacture of Multi-Layer Electrophotographic Photosensitive Member

### [Photosensitive Member A-1]

Hereinafter, manufacture of the photosensitive member A-1 according to Example 1 will be described. The photosensitive member A-1 is a multi-layer electrophotographic photosensitive member.

### (Formation of Intermediate Layer)

First, surface-treated titanium oxide (“SMT-A (trial product)”, product of Tayca Corporation, number average primary particle diameter: 10 nm) was prepared. More specifically, titanium oxide was surface-treated with alumina and silica, and the surface-treated titanium oxide was surface-treated with methyl hydrogen polysiloxane under wet dispersion. Subsequently, the surface-treated titanium oxide (2 parts by mass) and a four-component copolymer polyamide resin of Nylon 6, Nylon 12, Nylon 66, and Nylon 610 (Amilan (registered Japanese trademark) CM8000, product of Toray Industries, Inc.) (1 part by mass) were added to a solvent containing methanol (10 parts by mass), butanol (1 part by mass), and toluene (1 part by mass). These materials were mixed for 5 hours using a bead mill and dispersed in the solvent. Thus, an application liquid for intermediate layer formation was prepared.

The application liquid for intermediate layer formation thus obtained was filtered through a filter having a pore size of 5 μm. Thereafter, the application liquid for intermediate layer formation was applied onto a surface of a drum-shaped aluminum support (diameter: 30 mm, overall length: 246 mm) as a substrate by dip coating. Subsequently, the application liquid was dried at 130° C. for 30 minutes to form an intermediate layer (film thickness: 1 μm) on the substrate (drum-shaped support).

### (Formation of Charge Generating Layer)

A titanyl phthalocyanine that exhibits a peak at a Bragg angle 20±0.2° of 27.2° in a CuKα characteristic X-ray diffraction spectrum (1.5 parts by mass) and a polyvinyl acetal resin (“S-LEC BX-5”, product of Sekisui Chemical Co., Ltd.) as a base resin (1 part by mass) were added to a solvent containing propylene glycol monomethyl ether (40 parts by mass) and tetrahydrofuran (40 parts by mass). These materials were mixed for 2 hours using a bead mill and dispersed in the solvent to give the second application liquid. The second application liquid was filtered through a filter having a pore size of 3 μm. Then, the resulting filtrate was applied by dip coating onto the intermediate layer formed as described above and dried at 50° C. for 5 minutes. Thus, a charge generating layer (film thickness: 0.3 μm) was formed on the intermediate layer.

### (Formation of Charge Transport Layer)

CTM-1 as a hole transport material (42 parts by mass), a hindered phenol-based antioxidant (“Irganox (registered Japanese trademark) 1010”, product of BASF Japan Ltd.) as an additive (2 parts by mass), a polycarbonate resin (Resin-1, viscosity average molecular weight: 53,500) as a binder resin (100 parts by mass), and silica fine particles surface-treated with hexamethyldisilazane (“AEROSIL (registered Japanese trademark) RX200)”, product of Nippon Aerosil Co., Ltd.) (number average primary particle diameter: 12 nm) (5 parts by mass) were added to a solvent containing tetrahydrofuran (350 parts by mass) and toluene (350 parts by mass). The materials were mixed using a circulatory ultrasound disperser for 12 hours and dispersed in the solvent to give the third application liquid.

The third application liquid was applied onto the charge generating layer in the same manner as in the application of the second application liquid. Thereafter, the third application liquid was dried at 120° C. for 40 minutes to form a charge transport layer (film thickness: 30 μm) on the charge generating layer. As a result, the photosensitive member A-1 (multi-layer electrophotographic photosensitive member) was obtained. The photosensitive member A-1 had a structure in which the intermediate layer, the charge generating layer, and the charge transport layer were laminated to the substrate in the noted order.

### [Photosensitive Member A-2]

The photosensitive member A-2 was prepared in the same manner as in the preparation of the photosensitive member A-1 except that CTM-2 was used as a hole transport material instead of CTM-1.

### [Photosensitive Member A-3]

The photosensitive member A-3 was prepared in the same manner as in the preparation of the photosensitive member A-1 except that CTM-3 was used as a hole transport material instead of CTM-1.

### [Photosensitive Member A-4]

The photosensitive member A-4 was prepared in the same manner as in the preparation of the photosensitive member A-1 except that CTM-4 was used as a hole transport material instead of CTM-1.

### [Photosensitive Member A-5]

The photosensitive member A-5 was prepared in the same manner as in the preparation of the photosensitive member A-1 except that CTM-5 was used as a hole transport material instead of CTM-1.

### [Photosensitive Member A-6]

The photosensitive member A-6 was prepared in the same manner as in the preparation of the photosensitive member A-1 except that CTM-6 was used as a hole transport material instead of CTM-1.

### [Photosensitive Member A-7]

The photosensitive member A-7 was prepared in the same manner as in the preparation of the photosensitive member A-1 except that CTM-7 was used as a hole transport material instead of CTM-1.

### [Photosensitive Member A-8]

The photosensitive member A-8 was prepared in the same manner as in the preparation of the photosensitive member A-1 except that CTM-8 was used as a hole transport material instead of CTM-1.

### [Photosensitive Member A-9]

The photosensitive member A-9 was prepared in the same manner as in the preparation of the photosensitive member A-1 except that CTM-9 was used as a hole transport material instead of CTM-1.

### [Photosensitive Member A-10]

The photosensitive member A-10 was prepared in the same manner as in the preparation of the photosensitive member A-1 except that CTM-10 was used as a hole transport material instead of CTM-1.

### [Photosensitive Member A-11]

The photosensitive member A-11 was prepared in the same manner as in the preparation of the photosensitive member A-1 except that CTM-11 was used as a hole transport material instead of CTM-1.

### [Photosensitive Member A-12]

The photosensitive member A-12 was prepared in the same manner as in the preparation of the photosensitive member A-1 except that CTM-12 was used as a hole transport material instead of CTM-1.

### [Photosensitive Member A-13]

The photosensitive member A-13 was prepared in the same manner as in the preparation of the photosensitive member A-1 except that Resin-2 (viscosity average molecular weight: 49,900) was used as a binder resin instead of Resin-1.

### [Photosensitive Member A-14]

The photosensitive member A-14 was prepared in the same manner as in the preparation of the photosensitive member A-1 except that Resin-3 (viscosity average molecular weight: 51,200) was used as a binder resin instead of Resin-1.

### [Photosensitive Member A-15]

The photosensitive member A-15 was prepared in the same manner as in the preparation of the photosensitive member A-1 except that Resin-4 (viscosity average molecular weight: 50,500) was used as a binder resin instead of Resin-1.

### [Photosensitive Member A-16]

The photosensitive member A-16 was prepared in the same manner as in the preparation of the photosensitive member A-1 except that Resin-5 (viscosity average molecular weight: 50,200) was used as a binder resin instead of Resin-1.

### [Photosensitive Member A-17]

The photosensitive member A-17 was prepared in the same manner as in the preparation of the photosensitive member A-1 except that Resin-6 (viscosity average molecular weight: 48,500) was used as a binder resin instead of Resin-1.

### [Photosensitive Member A-18]

The photosensitive member A-18 was prepared in the same manner as in the preparation of the photosensitive member A-1 except that Resin-7 (viscosity average molecular weight: 50,100) was used as a binder resin instead of Resin-1.

### [Photosensitive Member A-19]

The photosensitive member A-19 was prepared in the same manner as in the preparation of the photosensitive member A-1 except that the viscosity average molecular weight of Resin-1 as a binder resin was adjusted to 40,100.

### [Photosensitive Member A-20]

The photosensitive member A-20 (multi-layer electrophotographic photosensitive member) was prepared in the same manner as in the preparation of the photosensitive member A-1 except that the viscosity average molecular weight of Resin-1 as a binder resin was adjusted to 33,000.

### [Photosensitive Member A-21]

The photosensitive member A-21 was prepared in the same manner as in the preparation of the photosensitive member A-1 except that silica fine particles surface-treated with hexamethyldisilazane (“AEROSIL (registered Japanese trademark) RX300”, product of Nippon Aerosil Co., Ltd.) (number average primary particle diameter: 7 nm) were used as silica fine particles instead of “AEROSIL (registered Japanese trademark) RX200”.

### [Photosensitive Member A-22]

The photosensitive member A-22 was prepared in the same manner as in the preparation of the photosensitive member A-1 except that silica fine particles surface-treated with hexamethyldisilazane (“AEROSIL (registered Japanese trademark) NAX50”, product of Nippon Aerosil Co., Ltd.) (number average primary particle diameter: 50 nm) were used as silica fine particles instead of “AEROSIL (registered Japanese trademark) RX200”.

### [Photosensitive Member A-23]

The photosensitive member A-23 was prepared in the same manner as in the preparation of the photosensitive member A-1 except that silica fine particles surface-treated with dimethyldichlorosilane (“AEROSIL (registered Japanese trademark) R974”, product of Nippon Aerosil Co., Ltd.) (number average primary particle diameter: 12 nm) were used as silica fine particles instead of “AEROSIL (registered Japanese trademark) RX200”.

### [Photosensitive Member A-24]

The photosensitive member A-24 was prepared in the same manner as in the preparation of the photosensitive member A-1 except that silica fine particles surface-treated with polydimethylsiloxane (“AEROSIL (registered Japanese trademark) RY200”, product of Nippon Aerosil Co., Ltd.) (number average primary particle diameter: 12 nm) were used as silica fine particles instead of “AEROSIL (registered Japanese trademark) RX200”.

### [Photosensitive Member A-25]

The photosensitive member A-25 was prepared in the same manner as in the preparation of the photosensitive member A-1 except that the amount of “AEROSIL (registered Japanese trademark) RX200” as silica fine particles was 0.5 parts by mass relative to 100 parts by mass of the binder resin.

### [Photosensitive Member A-26]

The photosensitive member A-26 was prepared in the same manner as in the preparation of the photosensitive member A-1 except that the amount of “AEROSIL (registered Japanese trademark) RX200” as silica fine particles was 2 parts by mass relative to 100 parts by mass of the binder resin.

### [Photosensitive Member A-27]

The photosensitive member A-27 was prepared in the same manner as in the preparation of the photosensitive member A-1 except that the amount of “AEROSIL (registered Japanese trademark) RX200” as silica fine particles was 10 parts by mass relative to 100 parts by mass of the binder resin.

### [Photosensitive Member A-28]

The photosensitive member A-28 was prepared in the same manner as in the preparation of the photosensitive member A-1 except that the amount of “AEROSIL (registered Japanese trademark) RX200” as silica fine particles was 15 parts by mass relative to 100 parts by mass of the binder resin.

### [Photosensitive Member B-1]

The photosensitive member B-1 was prepared in the same manner as in the preparation of the photosensitive member A-1 except that Resin-14 (viscosity average molecular weight: 50,000) was used as a binder resin instead of Resin-1. The composition of Resin-14 is represented by the following formula (45).

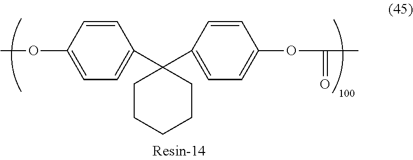

### [Photosensitive Member B-2]

The photosensitive member B-2 was prepared in the same manner as in the preparation of the photosensitive member A-1 except that no silica fine particles were used.

### [Photosensitive Member B-3]

The photosensitive member B-3 was prepared in the same manner as in the preparation of the photosensitive member B-1 except that no silica fine particles were used.

### [Evaluation of Performance of Electrophotographic Photosensitive Members]

### (Evaluation of Electrical Characteristic)

Each of the photosensitive members A-1 to A-28 and the photosensitive members B-1 to B-3 was charged to −800 V using a drum sensitivity test device (product of GEN-TECH, INC.) at a rotation speed of 31 rpm. Subsequently, the surface of the electrophotographic photosensitive member was irradiated with monochromatic light (wavelength: 780 nm, light amount: 1.0 μJ/cm²) extracted from light emitted from a halogen lamp through a bandpass filter. The surface potential was measured after a lapse of 50 milliseconds from the end of the monochromatic light irradiation to be determined as a residual potential (V_{L}). The measurement was performed at a temperature of 23° C. and a humidity of 50% RH.

### (Evaluation of Oil Cracking Resistance)

Oil (oleic triglyceride) was applied onto the surface of each of the photosensitive members A-1 to A-28 and the photosensitive members B-1 to B-3, and the photosensitive member was left to stand for two days. Thereafter, presence of cracks was observed using an optical microscope. The oil cracking resistance was evaluated according to the following criteria.

Very Good (VG): No crack was observed.
Good (G): 1 to 3 cracks were observed.
Acceptable (A): 4 to 10 cracks were observed.
Poor (P): No less than 11 cracks were observed.

### (Evaluation of Abrasion Resistance)

The application liquid for charge transport layer formation prepared in the manufacture of each of the photosensitive members A-1 to A-28 and the photosensitive members B-1 to B-3 was applied to a polypropylene sheet (thickness: 0.3 mm) wound around an aluminum pipe (diameter: 78 mm) The application liquid was dried at 120° C. for 40 minutes to give an abrasion resistance evaluation test sheet with a charge transport layer having a film thickness of 30 μm.

The charge transport layer was peeled away from the polypropylene sheet and attached to a specimen mounting card S-36 (product of TABER Industries) to give a sample. An abrasion resistance evaluation test was performed on each sample thus prepared as follows. That is, the sample was placed in a rotary abrasion tester (product of Toyo Seiki Seisaku-sho, Ltd.) and rotated 1000 times at a rotation speed of 60 rpm under a load of 500 gf with an abrasion wheel CS-10 (product of TABER Industries). The abrasion loss (mg/1000 rotations) was measured as a difference between the mass of the sample prior to the abrasion resistance evaluation test and the mass of the sample after the abrasion resistance evaluation test, and the abrasion resistance was evaluated based on the abrasion loss.

Table 1 shows components contained in the charge transport layers of the photosensitive members A-1 to A-28 and the photosensitive members B-1 to B-3. Table 2 shows performance evaluation results of the oil cracking resistance and the abrasion resistance of the photosensitive members A-1 to A-28 and the photosensitive members B-1 to B-3.

TABLE 1

| | Charge transport layer | | | | | | |
|---|---|---|---|---|---|---|---|
| | | | | Silica particles | | | |
| | | | | | | Average | |
| | Hole | | | | | primary | |
| Photo- | transport | Binder resin | | | | particle | Amount |
| sensitive | material | | Molecular | | | diameter | (parts by |
| member | Type | Type | weight | Type | Surface treatment agent | (nm) | mass) |
| A-1 | CTM-1 | Resin-1 | 53,500 | RX200 | Hexamethyldisilazane | 12 | 5 |
| A-2 | CTM-2 | Resin-1 | 53,500 | RX200 | Hexamethyldisilazane | 12 | 5 |
| A-3 | CTM-3 | Resin-1 | 53,500 | RX200 | Hexamethyldisilazane | 12 | 5 |
| A-4 | CTM-4 | Resin-1 | 53,500 | RX200 | Hexamethyldisilazane | 12 | 5 |
| A-5 | CTM-5 | Resin-1 | 53,500 | RX200 | Hexamethyldisilazane | 12 | 5 |
| A-6 | CTM-6 | Resin-1 | 53,500 | RX200 | Hexamethyldisilazane | 12 | 5 |
| A-7 | CTM-7 | Resin-1 | 53,500 | RX200 | Hexamethyldisilazane | 12 | 5 |
| A-8 | CTM-8 | Resin-1 | 53,500 | RX200 | Hexamethyldisilazane | 12 | 5 |
| A-9 | CTM-9 | Resin-1 | 53,500 | RX200 | Hexamethyldisilazane | 12 | 5 |
| A-10 | CTM-10 | Resin-1 | 53,500 | RX200 | Hexamethyldisilazane | 12 | 5 |
| A-11 | CTM-11 | Resin-1 | 53,500 | RX200 | Hexamethyldisilazane | 12 | 5 |
| A-12 | CTM-12 | Resin-1 | 53,500 | RX200 | Hexamethyldisilazane | 12 | 5 |
| A-13 | CTM-1 | Resin-2 | 49,900 | RX200 | Hexamethyldisilazane | 12 | 5 |
| A-14 | CTM-1 | Resin-3 | 51,200 | RX200 | Hexamethyldisilazane | 12 | 5 |
| A-15 | CTM-1 | Resin-4 | 50,500 | RX200 | Hexamethyldisilazane | 12 | 5 |
| A-16 | CTM-1 | Resin-5 | 50,200 | RX200 | Hexamethyldisilazane | 12 | 5 |
| A-17 | CTM-1 | Resin-6 | 48,500 | RX200 | Hexamethyldisilazane | 12 | 5 |
| A-18 | CTM-1 | Resin-7 | 50,100 | RX200 | Hexamethyldisilazane | 12 | 5 |
| A-19 | CTM-1 | Resin-1 | 40,100 | RX200 | Hexamethyldisilazane | 12 | 5 |
| A-20 | CTM-1 | Resin-1 | 33,000 | RX200 | Hexamethyldisilazane | 12 | 5 |
| A-21 | CTM-1 | Resin-1 | 53,500 | RX300 | Hexamethyldisilazane | 7 | 5 |
| A-22 | CTM-1 | Resin-1 | 53,500 | NAX50 | Hexamethyldisilazane | 50 | 5 |
| A-23 | CTM-1 | Resin-1 | 53,500 | R974 | Dimethyldichlorosilane | 12 | 5 |
| A-24 | CTM-1 | Resin-1 | 53,500 | RY200 | Polydimethylsiloxane | 12 | 5 |
| A-25 | CTM-1 | Resin-1 | 53,500 | RX200 | Hexamethyldisilazane | 12 | 0.5 |
| A-26 | CTM-1 | Resin-1 | 53,500 | RX200 | Hexamethyldisilazane | 12 | 2 |
| A-27 | CTM-1 | Resin-1 | 53,500 | RX200 | Hexamethyldisilazane | 12 | 10 |
| A-28 | CTM-1 | Resin-1 | 53,500 | RX200 | Hexamethyldisilazane | 12 | 15 |
| B-1 | CTM-1 | Resin-14 | 50,000 | RX200 | Hexamethyldisilazane | 12 | 5 |

| | | | | |
|---|---|---|---|---|
| B-2 | CTM-1 | Resin-1 | 52,500 | None |
| B-3 | CTM-1 | Resin-14 | 50,000 | None |

TABLE 2

| | Electrical | Oil cracking resistance | | Abrasion resistance |
|---|---|---|---|---|
| Photosensitive | characteristic | Number of | | Abrasion loss |
| member | V_{L} (V) | cracks | Evaluation | (mg/1000 rotations) |
| A-1 | −81 | 0 | VG | 3.9 |
| A-2 | −79 | 0 | VG | 3.2 |
| A-3 | −79 | 0 | VG | 3.3 |
| A-4 | −80 | 0 | VG | 3.7 |
| A-5 | −64 | 3 | G | 3.9 |
| A-6 | −78 | 3 | G | 3.6 |
| A-7 | −81 | 3 | G | 3.4 |
| A-8 | −99 | 0 | VG | 3.3 |
| A-9 | −91 | 3 | G | 3.9 |
| A-10 | −68 | 0 | VG | 3.1 |
| A-11 | −123 | 2 | G | 3.5 |
| A-12 | −116 | 6 | A | 3.5 |
| A-13 | −81 | 3 | G | 4.0 |
| A-14 | −79 | 0 | VG | 3.6 |
| A-15 | −80 | 2 | G | 4.0 |
| A-16 | −83 | 3 | G | 3.0 |
| A-17 | −79 | 0 | VG | 3.9 |
| A-18 | −82 | 3 | G | 3.5 |
| A-19 | −81 | 0 | VG | 3.9 |
| A-20 | −79 | 9 | A | 4.7 |
| A-21 | −80 | 0 | VG | 3.9 |
| A-22 | −80 | 0 | VG | 3.2 |
| A-23 | −82 | 8 | A | 3.4 |
| A-24 | −85 | 9 | A | 3.4 |
| A-25 | −81 | 0 | VG | 3.9 |
| A-26 | −77 | 0 | VG | 3.5 |
| A-27 | −80 | 3 | G | 3.6 |
| A-28 | −80 | 2 | G | 3.3 |
| B-1 | −85 | 28 | P | 5.4 |
| B-2 | −89 | 0 | VG | 5.3 |
| B-3 | −85 | 3 | G | 6.5 |

Tables 1 and 2 reveal the following with respect to the electrophotographic photosensitive members of the present disclosure. That is, the absolute value of the residual potential was small in the electrical characteristic evaluation. Occurrence of oil-induced cracking on the photosensitive layer surface was reduced. Furthermore, the abrasion loss in the photosensitive layer was small in the abrasion resistance test. It is therefore obvious that the electrophotographic photosensitive members according to the present disclosure each include a photosensitive layer having improved abrasion resistance and oil cracking resistance while maintaining excellent electrical characteristics.

### [Photosensitive Member C-1]

First, surface-treated titanium oxide (“SMT-A”, product of Tayca Corporation, number average primary particle diameter: 10 nm) was prepared. Specifically, titanium oxide was surface-treated with alumina and silica, and the surface-treated titanium oxide was surface-treated with methyl hydrogen polysiloxane under wet dispersion using a bead mill Subsequently, 2 parts by mass of the titanium oxide and 1 part by mass of a four-component copolymer polyamide resin of Nylon 6, Nylon 12, Nylon 66, and Nylon 610 (Amilan (registered Japanese trademark) CM8000, product of Toray Industries, Inc.) were added to a solvent containing 10 parts by mass of methanol, 1 part by mass of butanol, and 1 part by mass of toluene. These materials were mixed for 5 hours using a bead mill and dispersed in the solvent. Thus, an application liquid for intermediate layer formation was prepared.

The application liquid for intermediate layer formation thus obtained was filtered through a filter having a pore size of 5 μm. Thereafter, the application liquid for intermediate layer formation was applied by dip coating onto a surface of a drum-shaped aluminum substrate (support substrate) having a diameter of 30 mm and a length of 246 mm Subsequently, the application liquid for intermediate layer formation was dried at 130° C. for 30 minutes to form an intermediate layer having a film thickness of 2 μm on the substrate.

Next, 1.5 parts by mass of a titanyl phthalocyanine represented by the formula (46) that at least exhibits a peak at a Bragg angle 20±0.2° of 27.2° in a CuKα characteristic X-ray diffraction spectrum and 1 part by mass of a polyvinyl acetal resin (“S-LEC BX-5”, product of Sekisui Chemical Co., Ltd.) as a base resin were added to a solvent containing 40 parts by mass of propylene glycol monomethyl ether and 40 parts by mass of tetrahydrofuran. Subsequently, the materials were mixed for 2 hours using a bead mill and dispersed in the solvent to give an application liquid for charge generating layer formation. The application liquid for charge generating layer formation was filtered through a filter having a pore size of 3 μm. Then, the resulting filtrate was applied by dip coating onto the intermediate layer formed as described above and dried at 50° C. for 5 minutes. Thus, a charge generating layer having a film thickness of 0.3 μm was formed.

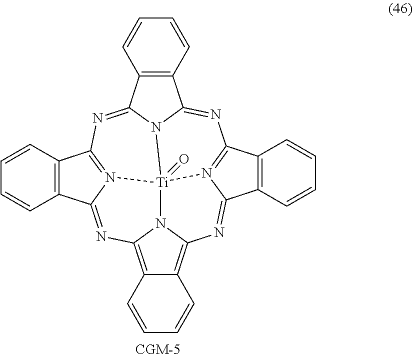

Next, 44 parts by mass of CTM-1 represented by the formula (10) as a hole transport material, 2 parts by mass of a hindered phenol-based antioxidant (“Irganox (registered Japanese trademark) 1010”, product of BASF Japan Ltd.) as an additive, 100 parts by mass of a polycarbonate resin (Resin-8, viscosity average molecular weight: 50,700) represented by the formula (47) as a binder resin, and 5 parts by mass of silica fine particles surface-treated with hexamethyldisilazane and having an average primary particle diameter of 12 nm (“RX200”, product of Nippon Aerosil Co., Ltd.) were added to a solvent containing 350 parts by mass of tetrahydrofuran and 350 parts by mass of toluene. These components were mixed using a circulatory ultrasound disperser for 12 hours and dispersed in the solvent to give an application liquid for charge transport layer formation. The application liquid for charge transport layer formation was applied onto the charge generating layer in the same manner as in the application of the application liquid for charge generating layer formation. Thereafter, the application liquid was dried at 120° C. for 40 minutes to form a charge transport layer having a film thickness of 30 μm. As a result, the photosensitive member C-1 (multi-layer electrophotographic photosensitive member) was obtained.

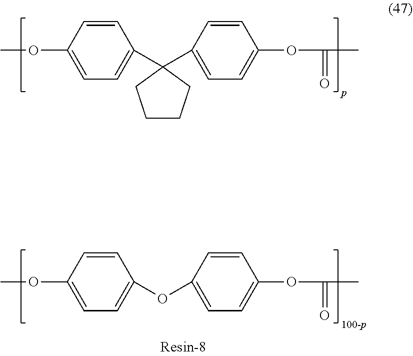

The value of p was 60.

### [Photosensitive Member C-2]

The photosensitive member C-2 was prepared in the same manner as in the preparation of the photosensitive member C-1 except that CTM-2 represented by the formula (11) was used as a hole transport material instead of CTM-1.

### [Photosensitive Member C-3]

The photosensitive member C-3 was prepared in the same manner as in the preparation of the photosensitive member C-1 except that CTM-3 represented by the formula (12) was used as a hole transport material instead of CTM-1.

### [Photosensitive Member C-4]

The photosensitive member C-4 was prepared in the same manner as in the preparation of the photosensitive member C-1 except that CTM-4 represented by the formula (13) was used as a hole transport material instead of CTM-1.

### [Photosensitive Member C-5]

The photosensitive member C-5 was prepared in the same manner as in the preparation of the photosensitive member C-1 except that CTM-5 represented by the formula (14) was used as a hole transport material instead of CTM-1.

### [Photosensitive Member C-6]

The photosensitive member C-6 was prepared in the same manner as in the preparation of the photosensitive member C-1 except that CTM-6 represented by the formula (15) was used as a hole transport material instead of CTM-1.

### [Photosensitive Member C-7]

The photosensitive member C-7 was prepared in the same manner as in the preparation of the photosensitive member C-1 except that CTM-7 represented by the formula (16) was used as a hole transport material instead of CTM-1.

### [Photosensitive Member C-8]

The photosensitive member C-8 was prepared in the same manner as in the preparation of the photosensitive member C-1 except that CTM-8 represented by the formula (17) was used as a hole transport material instead of CTM-1.

### [Photosensitive Member C-9]

The photosensitive member C-9 was prepared in the same manner as in the preparation of the photosensitive member C-1 except that CTM-9 represented by the formula (18) was used as a hole transport material instead of CTM-1.

### [Photosensitive Member C-10]

The photosensitive member C-10 was prepared in the same manner as in the preparation of the photosensitive member C-1 except that CTM-10 represented by the formula (19) was used as a hole transport material instead of CTM-1.

### [Photosensitive Member C-11]

The photosensitive member C-11 was prepared in the same manner as in the preparation of the photosensitive member C-1 except that Resin-9 (viscosity average molecular weight: 49,900) represented by the formula (48) was used as a binder resin instead of Resin-8.

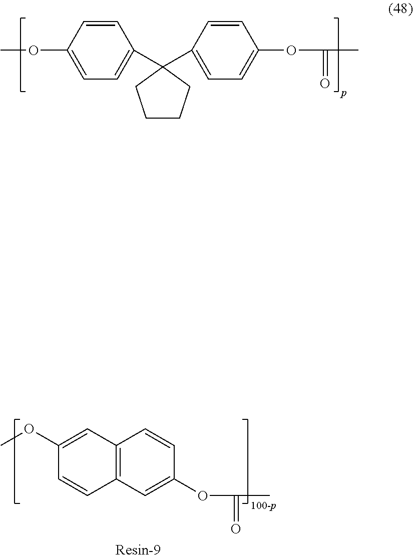

The value of p was 60.

### [Photosensitive Member C-12]

The photosensitive member C-12 was prepared in the same manner as in the preparation of the photosensitive member C-1 except that Resin-10 (viscosity average molecular weight: 50,100) represented by the formula (49) was used as a binder resin instead of Resin-8.

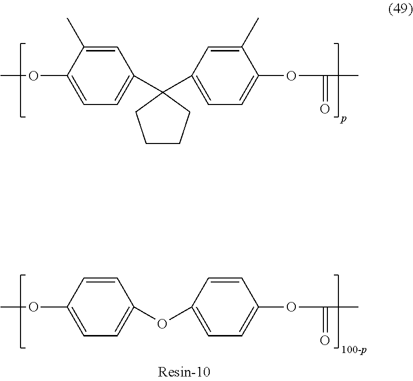

The value of p was 60.

### [Photosensitive Member C-13]

The photosensitive member C-13 was prepared in the same manner as in the preparation of the photosensitive member C-1 except that Resin-11 (viscosity average molecular weight: 49,800) represented by the formula (40) was used as a binder resin instead of Resin-8.

### [Photosensitive Member C-14]

The photosensitive member C-14 was prepared in the same manner as in the preparation of the photosensitive member C-1 except that Resin-12 (viscosity average molecular weight: 49,900) represented by the formula (41) was used as a binder resin instead of Resin-8.

### [Photosensitive Member C-15]

The photosensitive member C-15 was prepared in the same manner as in the preparation of the photosensitive member C-1 except that Resin-13 (viscosity average molecular weight: 50,900) represented by the formula (42) was used as a binder resin instead of Resin-8.

### [Photosensitive Member C-16]

The photosensitive member C-16 was prepared in the same manner as in the preparation of the photosensitive member C-1 except that the viscosity average molecular weight of Resin-8 as a binder resin was changed from 50,700 to 40,200.

### [Photosensitive Member C-17]

The photosensitive member C-17 was prepared in the same manner as in the preparation of the photosensitive member C-1 except that the viscosity average molecular weight of Resin-8 as a binder resin was changed from 50,700 to 30,500.

### [Photosensitive Member C-18]

The photosensitive member C-18 was prepared in the same manner as in the preparation of the photosensitive member C-1 except that silica fine particles RX300 (average primary particle diameter: 7 nm) were used instead of the silica fine particles RX200.

### [Photosensitive Member C-19]

The photosensitive member C-19 was prepared in the same manner as in the preparation of the photosensitive member C-1 except that silica fine particles NAX50 (average primary particle diameter: 50 nm) were used instead of the silica fine particles RX200.

### [Photosensitive Member C-20]

The photosensitive member C-20 was prepared in the same manner as in the preparation of the photosensitive member C-1 except that silica fine particles surface-treated with dimethyldichlorosilane (R974) were used instead of the silica fine particles surface-treated with hex amethyldisilazane (RX200).

### [Photosensitive Member C-21]

The photosensitive member C-21 was prepared in the same manner as in the preparation of the photosensitive member C-1 except that silica fine particles surface-treated with polydimethylsiloxane (RY200) were used instead of the silica fine particles surface-treated with hexamethyldisilazane (RX200).

### [Photosensitive Member C-22]

The photosensitive member C-22 was prepared in the same manner as in the preparation of the photosensitive member C-1 except that the amount of the silica fine particles was changed from 5 parts by mass to 0.5 parts by mass.

### [Photosensitive Member C-23]

The photosensitive member C-23 was prepared in the same manner as in the preparation of the photosensitive member C-1 except that the amount of the silica fine particles was changed from 5 parts by mass to 2 parts by mass.

### [Photosensitive Member C-24]

The photosensitive member C-24 was prepared in the same manner as in the preparation of the photosensitive member C-1 except that the amount of the silica fine particles was changed from 5 parts by mass to 10 parts by mass.

### [Photosensitive Member C-25]

The photosensitive member C-25 was prepared in the same manner as in the preparation of the photosensitive member C-1 except that the amount of the silica fine particles was changed from 5 parts by mass to 15 parts by mass.

### [Photosensitive Member D-1]

The photosensitive member D-1 was prepared in the same manner as in the preparation of the photosensitive member C-1 except that Resin-15 (viscosity average molecular weight: 51,000) represented by the formula (50) was used as a binder resin instead of Resin-8, and no silica fine particles were used.

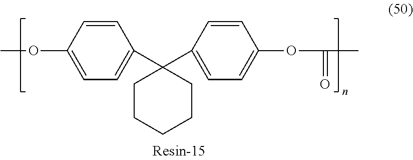

### [Photosensitive Member D-2]

The photosensitive member D-2 was prepared in the same manner as in the preparation of the photosensitive member C-1 except that Resin-15 (viscosity average molecular weight: 51,000) was used as a binder resin instead of Resin-8.

### [Photosensitive Member D-3]

The photosensitive member D-3 was prepared in the same manner as in the preparation of the photosensitive member C-1 except that no silica fine particles were used.

Table 3 shows components contained in the charge transport layers of the photosensitive members C-1 to C-25 and the photosensitive members D-1 to D-3.

TABLE 3

| | Charge transport layer | | | | | | | |
|---|---|---|---|---|---|---|---|---|
| | | | | | Silica fine particles | | | |
| | Hole transport | | | | | | Average | |
| | material | | | | | | primary | |
| Photo- | | Amount | Binder resin | | | | particle | Amount |
| sensitive | | (parts by | | Molecular | | | diameter | (parts by |
| member | Type | mass) | Type | weight | Type | Surface treatment agent | (nm) | mass) |
| C-1 | CTM-1 | 44 | Resin-8 | 50700 | RX200 | Hexamethyldisilazane | 12 | 5 |
| C-2 | CTM-2 | 44 | Resin-8 | 50700 | RX200 | Hexamethyldisilazane | 12 | 5 |
| C-3 | CTM-3 | 44 | Resin-8 | 50700 | RX200 | Hexamethyldisilazane | 12 | 5 |
| C-4 | CTM-4 | 44 | Resin-8 | 50700 | RX200 | Hexamethyldisilazane | 12 | 5 |
| C-5 | CTM-5 | 44 | Resin-8 | 50700 | RX200 | Hexamethyldisilazane | 12 | 5 |
| C-6 | CTM-6 | 44 | Resin-8 | 50700 | RX200 | Hexamethyldisilazane | 12 | 5 |
| C-7 | CTM-7 | 44 | Resin-8 | 50700 | RX200 | Hexamethyldisilazane | 12 | 5 |
| C-8 | CTM-8 | 44 | Resin-8 | 50700 | RX200 | Hexamethyldisilazane | 12 | 5 |
| C-9 | CTM-9 | 44 | Resin-8 | 50700 | RX200 | Hexamethyldisilazane | 12 | 5 |
| C-10 | CTM-10 | 44 | Resin-8 | 50700 | RX200 | Hexamethyldisilazane | 12 | 5 |
| C-11 | CTM-1 | 44 | Resin-9 | 49900 | RX200 | Hexamethyldisilazane | 12 | 5 |
| C-12 | CTM-1 | 44 | Resin-10 | 50100 | RX200 | Hexamethyldisilazane | 12 | 5 |
| C-13 | CTM-1 | 44 | Resin-11 | 49800 | RX200 | Hexamethyldisilazane | 12 | 5 |
| C-14 | CTM-1 | 44 | Resin-12 | 49900 | RX200 | Hexamethyldisilazane | 12 | 5 |
| C-15 | CTM-1 | 44 | Resin-13 | 50900 | RX200 | Hexamethyldisilazane | 12 | 5 |
| C-16 | CTM-1 | 44 | Resin-8 | 40200 | RX200 | Hexamethyldisilazane | 12 | 5 |
| C-17 | CTM-1 | 44 | Resin-8 | 30500 | RX200 | Hexamethyldisilazane | 12 | 5 |
| C-18 | CTM-1 | 44 | Resin-8 | 50700 | RX300 | Hexamethyldisilazane | 7 | 5 |
| C-19 | CTM-1 | 44 | Resin-8 | 50700 | NAX50 | Hexamethyldisilazane | 50 | 5 |
| C-20 | CTM-1 | 44 | Resin-8 | 50700 | R974 | Dimethyldichlorosilane | 12 | 5 |
| C-21 | CTM-1 | 44 | Resin-8 | 50700 | RY200 | Polydimethylsiloxane | 12 | 5 |
| C-22 | CTM-1 | 44 | Resin-8 | 50700 | RX200 | Hexamethyldisilazane | 12 | 0.5 |
| C-23 | CTM-1 | 44 | Resin-8 | 50700 | RX200 | Hexamethyldisilazane | 12 | 2 |
| C-24 | CTM-1 | 44 | Resin-8 | 50700 | RX200 | Hexamethyldisilazane | 12 | 10 |
| C-25 | CTM-1 | 44 | Resin-8 | 50700 | RX200 | Hexamethyldisilazane | 12 | 15 |
| D-1 | CTM-1 | 44 | Resin-15 | 51000 | — | — | — | — |
| D-2 | CTM-1 | 44 | Resin-15 | 51000 | RX200 | Hexamethyldisilazane | 12 | 5 |
| D-3 | CTM-1 | 44 | Resin-8 | 50700 | — | — | — | — |

### <Evaluation of Performance of Electrophotographic Photosensitive Members>

### (1) Evaluation of Electrical Characteristic

Each of the photosensitive members C-1 to C-25 and the photosensitive members D-1 to D-3 was charged to −800 V using a drum sensitivity test device (product of GEN-TECH, INC.) at a rotation speed of 31 rpm. Subsequently, the surface of the multi-layer electrophotographic photosensitive member was irradiated with monochromatic light (wavelength: 780 nm, light amount: 1.0 μJ/cm²) extracted from light emitted from a halogen lamp through a bandpass filter. The surface potential was measured after a lapse of 50 milliseconds from the end of the monochromatic light irradiation to be determined as an initial residual potential (V_{L}(initial)). The measurement was performed at a temperature of 23° C. and a humidity of 50% RH. The electrical characteristic of the photosensitive members were rated insufficient when V_{L}(initial) was less than −100 V, and the electrical characteristic of the photosensitive members were rated good when V_{L}(initial) was no less than −100 V.

### (2) Evaluation of Ozone Resistance

Each of the photosensitive members was stored under an atmosphere having an ozone concentration of 50 ppm for 12 hours. The surface potential of each photosensitive member immediately after the ozone exposure was measured in the same manner as in the above-described surface potential measurement to be a post-ozone exposure surface potential (V_{L}(post-ozone exposure)). The measurement was performed at a temperature of 23° C. and a humidity of 50% RH. ΔV_{L} was calculated in accordance with the following equation.

ΔV_{L} [V]=V_{L}(initial)−V_{L}(post-ozone exposure)

The ozone resistance of the photosensitive members was rated insufficient when ΔV_{L} was greater than 15 V, and the ozone resistance of the photosensitive members was rated good when ΔV_{L} was no greater than 15 V.

### (3) Evaluation of Abrasion Resistance

The application liquid for charge transport layer formation prepared in the manufacture of each of the photosensitive members C-1 to C-25 and the photosensitive members D-1 to D-3 was applied onto a polypropylene sheet (thickness: 0.3 mm) wound around an aluminum pipe (diameter: 78 mm) The application liquid was dried at 120° C. for 40 minutes to give an abrasion resistance evaluation test sheet with a charge transport layer having a film thickness of 30 μm.

The charge transport layer was peeled away from the polypropylene sheet and attached to a specimen mounting card S-36 (product of TABER Industries) to give a sample. An abrasion evaluation test was performed on each sample thus prepared as follows. That is, the sample was placed in a rotary ablation tester (product of Toyo Seiki Seisaku-sho, Ltd.) and rotated 1000 times at a rotation speed of 60 rpm under a load of 500 gf with an abrading wheel CS-10 (product of TABER Industries). The abrasion loss was measured as a difference between the mass of the sample prior to the abrasion resistance evaluation test and the mass of the sample after the abrasion resistance evaluation test, and the abrasion resistance of each photosensitive member was evaluated based on the abrasion loss. The abrasion resistance of the photosensitive members was rated insufficient when the abrasion loss was greater than 5.0 mg, and the abrasion resistance of the photosensitive members was rated good when the abrasion loss was no greater than 5.0 mg.

Table 4 shows results of the electrical characteristic evaluation, the ozone resistance evaluation, and the abrasion resistance evaluation of the photosensitive members C-1 to C-25 and the photosensitive members D-1 to D-3.

Table 4

| | | Ozone resistance | | |
|---|---|---|---|---|
| | Electrical | V_{L}(post- | | Abrasion resistance |
| | characteristic | ozone | | Abrasion loss |
| Photosensitive | V_{L} (initial) | exposure) | ΔV_{L} | (mg/1000 rotations) |
| member | [V] | [V] | [V] | [mg] |
| C-1 | −85 | −92 | 7 | 3.1 |
| C-2 | −82 | −91 | 9 | 3.1 |
| C-3 | −83 | −92 | 9 | 3.1 |
| C-4 | −85 | −91 | 6 | 3.5 |
| C-5 | −79 | −84 | 5 | 3.6 |
| C-6 | −82 | −87 | 5 | 3.6 |
| C-7 | −85 | −91 | 6 | 3.2 |
| C-8 | −84 | −93 | 9 | 3.2 |
| C-9 | −86 | −94 | 8 | 3 |
| C-10 | −81 | −89 | 8 | 3.3 |
| C-11 | −85 | −92 | 7 | 3.1 |
| C-12 | −83 | −90 | 7 | 3.5 |
| C-13 | −81 | −87 | 6 | 4.1 |
| C-14 | −81 | −88 | 7 | 4.2 |
| C-15 | −84 | −91 | 7 | 4.1 |
| C-16 | −84 | −90 | 6 | 4.2 |
| C-17 | −85 | −96 | 11 | 4.9 |
| C-18 | −85 | −95 | 10 | 3.7 |
| C-19 | −85 | −94 | 9 | 3.5 |
| C-20 | −84 | −97 | 13 | 4.2 |
| C-21 | −90 | −103 | 13 | 4.2 |
| C-22 | −85 | −93 | 8 | 3.8 |
| C-23 | −84 | −93 | 9 | 3.7 |
| C-24 | −85 | −94 | 9 | 3.3 |
| C-25 | −83 | −92 | 9 | 3.4 |
| D-1 | −85 | −110 | 25 | 6.8 |
| D-2 | −85 | −106 | 21 | 5.9 |
| D-3 | −82 | −95 | 13 | 6.1 |

The electrophotographic photosensitive members according to the present embodiment had the following results. That is, the absolute value of the initial surface potential was small in the electrical characteristic evaluation. The change between the surface potential before the ozone exposure and the surface potential after the ozone exposure was small in the ozone resistance evaluation. Furthermore, the abrasion loss was small in the abrasion resistance test. It is therefore obvious that the electrophotographic photosensitive members according to the present embodiment have improved ozone resistance and abrasion resistance while maintaining excellent electrical characteristics.

What is claimed is:

1. An electrophotographic photosensitive member comprising a photosensitive layer, wherein
the photosensitive layer is
a multi-layer photosensitive layer including a laminate of a charge generating layer containing a charge generating material and a charge transport layer containing a charge transport material, a binder resin, and silica particles, the charge transport layer being an outermost layer, or
a single-layer photosensitive layer containing a charge generating material, a charge transport material, a binder resin, and silica particles,
the silica particles are contained in the photosensitive layer in an amount of no less than 0.5 parts by mass and no greater than 15 parts by mass relative to 100 parts by mass of the binder resin, and
the binder resin includes a polycarbonate resin represented by the general formula (1a) or the general formula (1b): 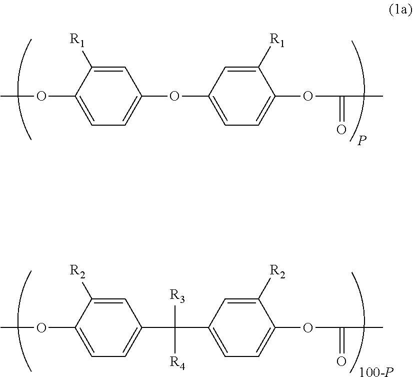
wherein R₁ and R₂ each independently represent a hydrogen atom, or a substituted or unsubstituted alkyl group, R₃ and R₄ each independently represent a hydrogen atom, a substituted or unsubstituted alkyl group, or a substituted or unsubstituted aryl group, R₃ and R₄ may be joined together to form a cycloalkylidene group, P is greater than 0 and no greater than 100, and P and 100-P each represent the proportion of a repeating structural unit in the polycarbonate resin; or 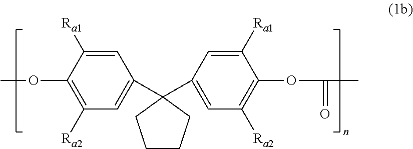
wherein Ra₁ and Ra₂ each independently represent a hydrogen atom or an alkyl group having 1 to 3 carbon atoms.

2. The electrophotographic photosensitive member according to claim 1, wherein P is no less than 25 and no greater than 70 in the general formula (1a).

3. The electrophotographic photosensitive member according to claim 1, wherein the silica particles are silica particles surface-treated with hexamethyldisilazane.

4. The electrophotographic photosensitive member according to claim 1, wherein the charge transport material includes a compound having two or more styryl groups and one or more aryl groups.

5. The electrophotographic photosensitive member according to claim 1, wherein the binder resin has a viscosity average molecular weight of no less than 40,000.

6. The electrophotographic photosensitive member according to claim 1, wherein the binder resin includes a polycarbonate resin having a copolymer structure of a structural unit represented by the general formula (1b) and a structural unit represented by the general formula (2) or the general formula (3): 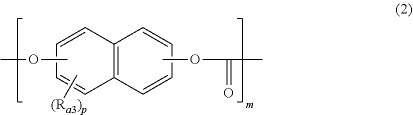
wherein Ra₃ represents a hydrogen atom, an alkyl group having 1 to 3 carbon atoms, a fluoroalkyl group, a halogen atom, or a phenyl group, and p is an integer from 1 to 8; or 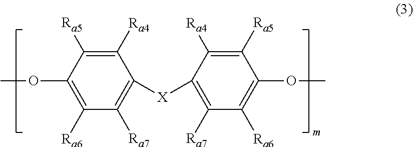
wherein: X represents a single bond, —O—, —S—, —CO—, —COO—, —(CH₂)₂—, —SO—, —SO₂—, —CRa₈Ra₉—, —SiRa₈Ra₉—, or —SiRa₈Ra₉—O—, where Ra₈ and Ra₉ independently represent a hydrogen atom, an alkyl group having 1 to 8 carbon atoms, a substituted or unsubstituted aryl group, or a trifluoromethyl group, Ra₈ and Ra₉ may independently be an alkyl ring having 2 to 4 carbon atoms or a benzene ring, Ra₈ and Ra₉ may be joined together to form a cycloalkylidene group, and when Ra₈ and Ra₉ are joined together to form a cycloalkylidene group, the cycloalkylidene group may have a substituent having 5 to 12 carbon atoms; and Ra₄ to Ra₇ each independently represent a hydrogen atom, an alkyl group having 1 to 3 carbon atoms, a fluoroalkyl group, a halogen atom, or a phenyl group.

7. The electrophotographic photosensitive member according to claim 1, wherein Ra₁ or Ra₂ of the structural unit represented by the general formula (1b) is a hydrogen atom.

8. The electrophotographic photosensitive member according to claim 1, wherein the charge transport material is a compound represented by any of the general formulae (4) to (7): 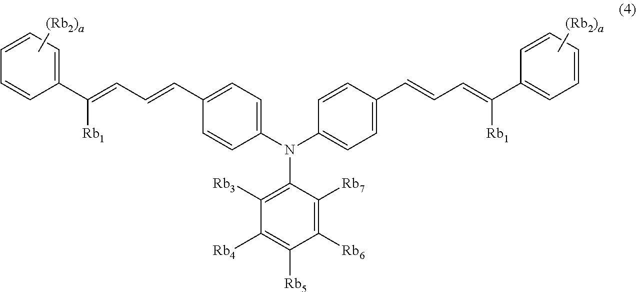
wherein Rb₁ to Rb₇ each independently represent a hydrogen atom, an alkyl group having 1 to 8 carbon atoms, an alkoxy group, or a phenyl group, or any adjacent two of Rb₃ to Rb₇ may be joined together to form an alkyl ring having 4 to 6 carbon atoms or a benzene ring, and a represents an integer from 0 to 5; 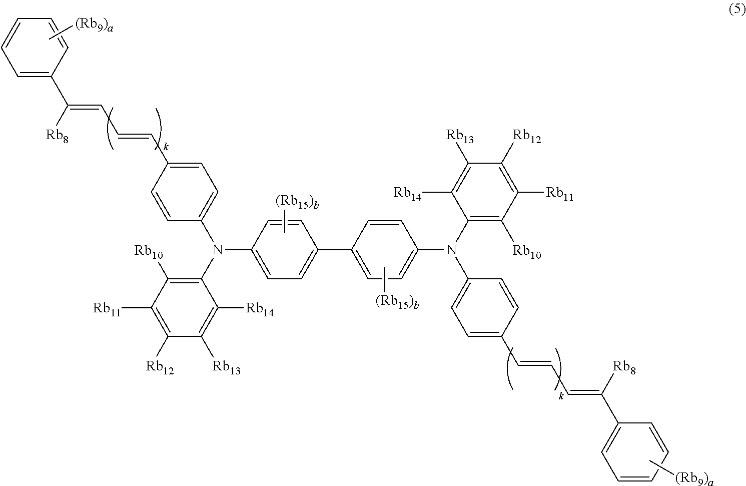
wherein Rb₈ to Rb₁₅ each independently represent a hydrogen atom, an alkyl group having 1 to 8 carbon atoms, a phenyl group, an alkoxy group, a is an integer from 0 to 5, b is an integer from 0 to 4, and k is 0 or 1; 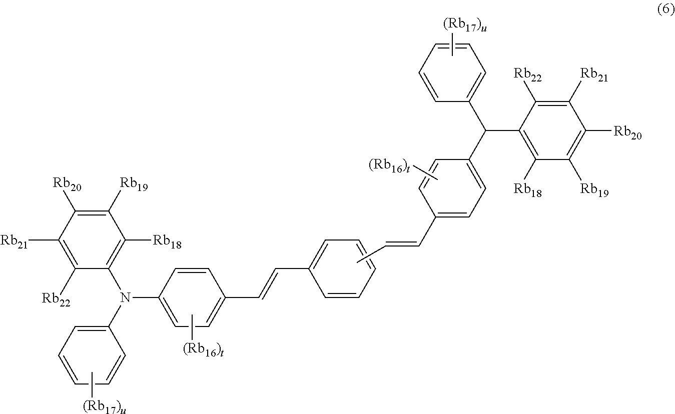
wherein Rb₁₆ to Rb₂₂ each independently represent a hydrogen atom, an alkyl group having 1 to 8 carbon atoms, a phenyl group, or an alkoxy group, t is an integer from 0 to 4, and u is an integer from 0 to 5; or 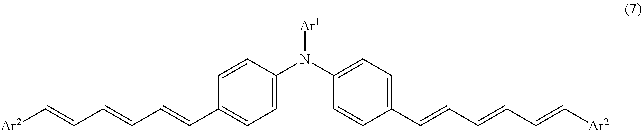
wherein Ar₁ represents an aryl group or a heterocyclic group having conjugated double bonds, Ar₂ represents an aryl group, and Ar₁ and Ar₂ may independently be substituted with one or more groups selected from the group consisting of an alkyl group having 1 to 6 carbon atoms, a phenoxy group, and an alkoxy group.
